(19) United States
(12) Patent Application Publication
(10) Pub. No.: US 2026/0004633 A1
(43) Pub. Date: Jan. 1, 2026

(54) GAME SYSTEM, GAME CONTROL METHOD, AND NON-TRANSITORY COMPUTER-READABLE RECORDING MEDIUM

(71) Applicant: KONAMI AMUSEMENT CO., LTD., Aichi (JP)

(72) Inventors: Go SOBONITA, Aichi (JP); Shinya SUGA, Aichi (JP)

(73) Assignee: KONAMI AMUSEMENT CO., LTD., Aichi (JP)

(21) Appl. No.: 19/320,600

(22) Filed: Sep. 5, 2025

Related U.S. Application Data
(63) Continuation of application No. PCT/JP2024/010283, filed on Mar. 15, 2024.

(30) Foreign Application Priority Data
Mar. 28, 2023 (JP) 2023-052095

(51) Int. Cl. G07F 17/32

(52) U.S. Cl. CPC G07F 17/322; G07F 17/3211; G07F 17/329

(57) ABSTRACT

A game system includes one or more memories configured to store instructions and one or more processors configured to execute the instructions to display, on a display, a lottery card including a plurality of squares divided into a plurality of display columns, each of the plurality of display columns including two or more squares aligned along a first axis, the plurality of display columns being arranged along a second axis intersecting the first axis, repeatedly select one or more squares from among the plurality of squares by lottery, consider, among the two or more squares included in each of the plurality of display columns in the lottery card, two squares disposed at opposite ends from each other in a direction of the first axis, as adjacent squares, and determine whether a line of a predetermined number of squares that are in a selected state is completed.

### CROSS REFERENCE TO RELATED APPLICATIONS

This application is a Continuation Application of PCT Application No. PCT/JP2024/010283, filed on Mar. 15, 2024, and is based on, and claims priority from, Japanese Patent Application No. 2023-052095, filed on Mar. 28, 2023, the entire contents of each of which are incorporated herein by reference.

### BACKGROUND

### Field of the Invention

This disclosure relates to games.

### Related Art

There have been conventionally proposed various lottery games in which a lottery card is used in which a plurality of squares are arranged in a matrix. For example, Japanese Patent No. 5790595 discloses a bingo game in which a line of five squares along a vertical direction among a plurality of squares can be moved in an up-down direction. However, in a state in which, for example, squares selected by lotteries are dispersed throughout a lottery card, even if a line of five squares is moved as in Japanese Patent No. 5790595, a user may think that the possibility of completion of bingo is sufficiently low. Thus, there is a problem in that a user's expectation is reduced with progress of a lottery game.

### SUMMARY

In view of the circumstances described above, an object of an aspect of this disclosure is to maintain a user's expectation of completion of a line of a predetermined number of squares over a long period of progress of a lottery game.

To solve the above problems, a game system according to an aspect of this disclosure includes one or more memories configured to store instructions and one or more processors configured to execute the instructions to display, on a display, a lottery card including a plurality of squares divided into a plurality of display columns, each of the plurality of display columns including two or more squares aligned along a first axis, the plurality of display columns being arranged along a second axis intersecting the first axis, repeatedly select one or more squares from among the plurality of squares by lottery, consider, among the two or more squares included in each of the plurality of display columns in the lottery card, two squares disposed at opposite ends from each other in a direction of the first axis, as adjacent squares, and determine whether a line of a predetermined number of squares that are in a selected state is completed.

A game control method according to an aspect of this disclosure includes displaying, by a game system, on a display, a lottery card including a plurality of squares divided into a plurality of display columns, each of the plurality of display columns including two or more squares aligned along a first axis, the plurality of display columns being arranged along a second axis intersecting the first axis, repeatedly selecting, by the game system, one or more squares from among the plurality of squares by lottery, and considering, by the game system, among the two or more squares included in each of the plurality of display columns in the lottery card, two squares disposed at opposite ends from each other in a direction of the first axis, as adjacent squares, and determining, by the game system, whether a line of a predetermined number of squares that are in a selected state is completed.

A non-transitory computer-readable recording medium according to an aspect of this disclosure is a non-transitory computer-readable recording medium storing instructions executable by a computer system configured to execute the instructions to display, on a display, a lottery card including a plurality of squares divided into a plurality of display columns, each of the plurality of display columns including two or more squares aligned along a first axis, the plurality of display columns being arranged along a second axis intersecting the first axis, repeatedly select one or more squares from among the plurality of squares by lottery, consider, among the two or more squares included in each of the plurality of display columns in the lottery card, two squares disposed at opposite ends from each other in a direction of the first axis, as adjacent squares, and determine whether a line of a predetermined number of squares that are in a selected state is completed.

### BRIEF DESCRIPTION OF THE DRAWINGS

FIG. 1 is a plan view of an example of a configuration of a game system according to an embodiment.

FIG. 2 is an explanatory diagram relating to progress of a game.

FIG. 3 is a plan view of a station.

FIG. 4 is a block diagram showing the game system.

FIG. 5 is a flowchart showing usual game processing.

FIG. 6 is a front view of a lottery unit U1 used for a first special lottery.

FIG. 7 is an explanatory diagram showing the first special lottery.

FIG. 8 is an explanatory diagram relating to display of a lottery card.

FIG. 9 is a plan view of a selection apparatus.

FIG. 10 is an explanatory diagram showing lines completed in the lottery card.

FIG. 11 is a flowchart showing the first special lottery.

FIG. 12 is a front view of a lottery unit U2 used for a second special lottery.

FIG. 13 is an explanatory diagram showing a lottery card in the second special lottery.

FIG. 14 is an explanatory diagram showing the lottery card in the second special lottery.

FIG. 15 is a flowchart showing the second special lottery.

FIG. 16 is a flowchart showing the second special lottery.

FIG. 17 is a front view of a lottery unit U3 used for a third special lottery.

FIG. 18 is an explanatory diagram relating to a preliminary lottery.

FIG. 19 is an explanatory diagram relating to each state of an option in the preliminary lottery.

FIG. 20 is a flowchart showing an initial lottery.

FIG. 21 is an explanatory diagram showing an additional lottery.

FIG. 22 is a schematic diagram showing reward patterns.

FIG. 23 is a schematic diagram showing a control table.

FIG. 24 is a flowchart showing the additional lottery.

FIG. 25 is an explanatory diagram showing a modification of the second special lottery.

### DESCRIPTION OF EMBODIMENTS

Embodiments according to this disclosure will be described with reference to the drawings. The embodiments described below include a variety of limitations not essential to this disclosure. Thus, the scope of this disclosure is not limited to the embodiments described below.

### EMBODIMENTS

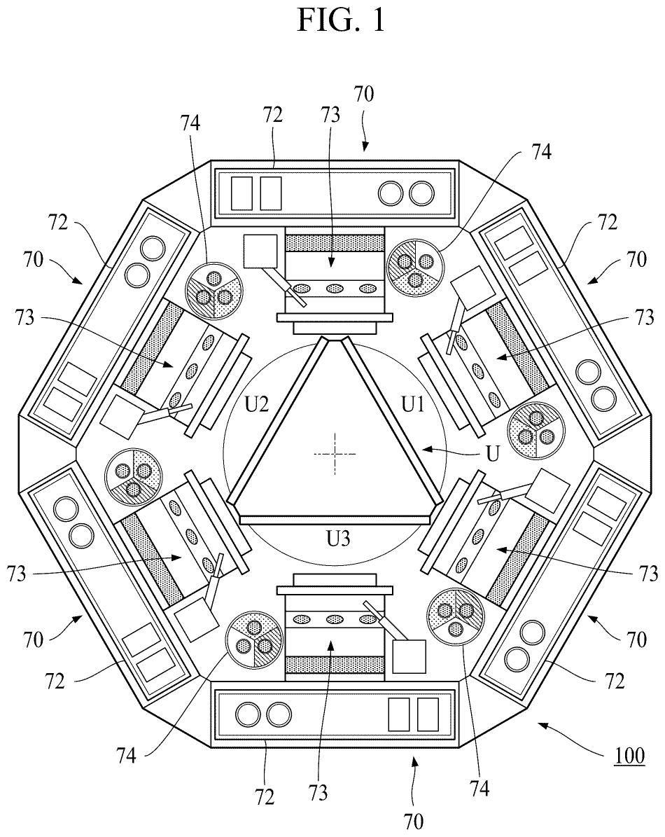

FIG. 1 is a plan view of a game system 100 according to an aspect of this disclosure. The game system 100 is provided in an amusement facility, for example. The amusement facility is an entertainment facility, such as an amusement arcade or a casino, or a commercial facility such as a shopping center, for example. The game system 100 provides games to a plurality of users (in other words, players) in the amusement facility. It should be noted that the game system 100, which is used in a casino, may be referred to as a gaming machine, for example.

As shown in FIG. 1, the game system 100 includes a central unit U and a plurality of stations 70. The plurality of stations 70 are circumferentially arranged to surround the central unit U. Each of the plurality of stations 70 is a unit used by a user to play a game. In the plurality of stations 70, games are progressed in parallel by different players. It should be noted that in FIG. 1, six stations 70 are shown; however, the number of stations 70 may be freely selected.

The central unit U, which is a lottery mechanism shared by the plurality of stations 70, is supported in a state in which rotations about an axis along a vertical direction can be carried out. The central unit U includes three lottery units U1 to U3 corresponding to different attributes An (n=1 to 3). Each of the attributes An is a color that symbolizes a lottery unit Un. For example, the attribute A1 is yellow, the attribute A2 is blue, and the attribute A3 is red. The three lottery units U1 to U3 differ in configuration. Rotation of the central unit U causes a lottery unit Un among the three lottery units U1 to U3 to face a specific station 70. It should be noted that the attribute An is not limited to a color. For example, the attribute An may be an element such as a specific name (for example, a country name, etc.) or a character.

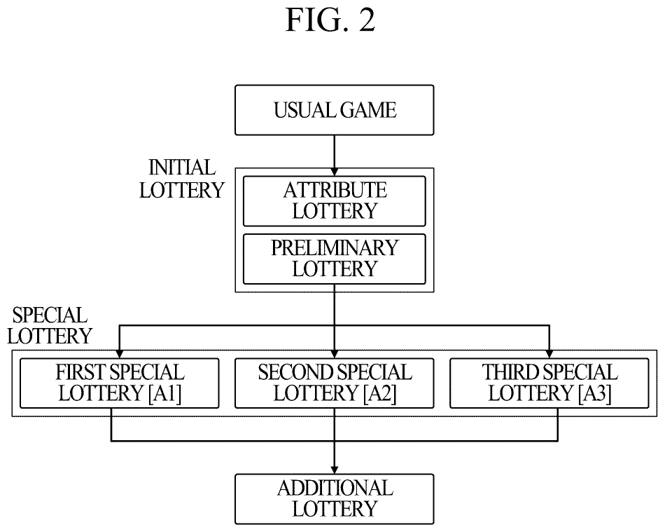

FIG. 2 is an explanatory diagram relating to progress of the game according to this embodiment. As shown in FIG. 2, in the game system 100 according to this embodiment, a usual game, an initial lottery, a special lottery, and an additional lottery are executed. The usual game is a game steadily played by each of the users using a station 70. In the respective stations 70, usual games are progressed in parallel

The special lottery, which is a lottery process of determining whether a user wins or loses, is executed by the central unit U. Special rewards (jackpots) are given to a user who wins the special lottery. As shown in FIG. 2, three types of special lotteries corresponding to the different attributes An are provided. For a special lottery (n-th special lottery) for an attribute An that is any one of the attributes An, a lottery unit Un corresponding to the attribute An is used among the three lottery units U1 to U3 of the central unit U. In other words, the lottery unit U1 is used for a first special lottery, the lottery unit U2 is used for a second special lottery, and the lottery unit U3 is used for a third special lottery. As described above, the lottery units Un differ in configuration; thus, a way to execute a special lottery differs between the respective attributes An. It should be noted that the central unit U is an example of a “special lottery executor.”

In FIG. 2, the initial lottery is executed in a station 70, at which a predetermined condition is satisfied in the usual game, among the plurality of stations 70. The initial lottery is a lottery process of holding a lottery to determine whether a user wins or loses. Specifically, the initial lottery includes an attribute lottery and a preliminary lottery.

The attribute lottery is a lottery process of determining one of the three types of attributes A1 to A3. The preliminary lottery is a lottery process of determining whether to permit the special lottery to be played. In other words, the special lottery corresponding to the attribute An determined by the attribute lottery is executed, subject to a win in the preliminary lottery. Subject to a loss in the preliminary lottery, the usual game is resumed whereas the special lottery is not executed.

The additional lottery is additionally executed subject to a win in the special lottery. The additional lottery is a lottery process of determining a quantity of rewards (hereinafter referred to as “additional rewards”) to be added to the special rewards. Subject to a loss in the special lottery, the usual game is resumed, whereas the additional lottery is not executed. In addition, after the additional lottery is executed, the usual game is resumed. The preliminary lottery is an example of a “first lottery,” and the additional lottery is an example of a “second lottery.”

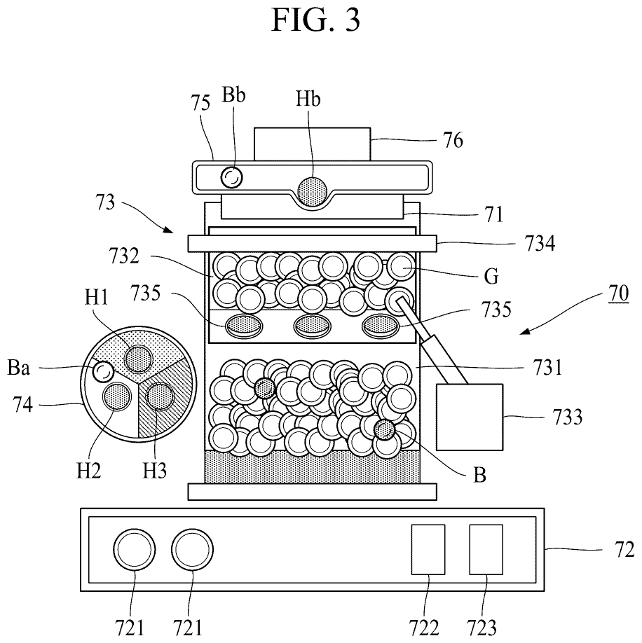

FIG. 3 is a plan view of each of the plurality of stations 70. As shown in FIG. 3, each of the plurality of stations 70 includes a display 71, an operation panel 72, a game apparatus 73, a lottery apparatus 74, a lottery apparatus 75, and a feeding apparatus 76.

The display 71 displays a variety of types of images. The display 71 is constituted of, for example, a display panel such as a liquid crystal panel or an organic EL (Electroluminescent) panel. The operation panel 72 is an input device for receiving operations made by a user. Specifically, the operation panel 72 includes operation devices 721, a receiving device 722, a payout device 723. The operation devices 721 are elements that are operable by the user. It should be noted that touch panels for detecting contact made by the user may be used as the operation devices 721.

The receiving device 722 receives medals from the user. Specifically, the receiving device 722 receives physical medals G and electronic medals from the user. The physical medals G are disc-shaped tangible game values. The electronic medals are intangible game values realized by electronic data. A mechanism, which is included in the receiving device 722 and receives the physical medals G, includes an insertion port into which the physical medals G are inserted, and a detector for detecting the physical medals G inserted into the insertion port. In addition, a mechanism, which is included in the receiving device 722 and receives the electronic medals, is a communication device for communicating with an account management system (not shown) for managing an electronic medal account for the user, for example. For example, the receiving device 722 executes a process of withdrawing the electronic medals by communicating with the account management system. It should be noted that a communication device, which is configured to execute a process of withdrawing the electronic medals by executing near-field communication with a recording medium for storing a quantity of electronic medals, may be used as the receiving device 722.

Medals, which are received by the receiving device 722 from the user, are exchanged for credits. Specifically, a numerical value corresponding to the quantity of medals received by the receiving device 722 is added to credits possessed by the user. The credits are game values to be consumed by the user to play the game.

The payout device 723 outputs medals. Specifically, a quantity of medals corresponding to the credits possessed by the user are output by the payout device 723. A mechanism, which is included in the payout device 723 and outputs physical medals G, includes a storage container for storing physical medals G, and an output mechanism for sequentially outputting physical medals G included in the storage container. In addition, a mechanism, which is included in the payout device 723 and outputs electronic medals, is a communication device that executes a process of depositing electronic medals by communicating with the account management system described above. It should be noted that a communication device, which is configured to execute a process of depositing the electronic medals by executing near-field communication with a recording medium for storing a quantity of electronic medals, may be used as the payout device 723.

The game apparatus 73 is a mechanism for providing the usual game to the user. The game apparatus 73 according to this embodiment is a pusher game machine that includes a fixed table 731, a movable table 732, a feeding apparatus 733, and a fixed wall 734.

The fixed table 731 is a flat plate material provided substantially horizontally. The movable table 732 is a three-dimensional structure (pusher table) that reciprocates on the fixed table 731. A large quantity of physical medals G is placed on the fixed table 731 and on the movable table 732.

The feeding apparatus 733 feeds a physical medal G onto the movable table 732 in response to an operation made by the user to the operation devices 721. In addition, the feeding apparatus 733 feeds a physical medal G onto the movable table 732 in exchange for use of an electronic medal or a credit received from the user.

The fixed wall 734 is a structure facing an upper surface of the movable table 732. The physical medals G placed on the movable table 732 are pressed forward by the fixed wall 734 when the movable table 732 moves backward. A plurality of physical medals G, which has been pressed by the fixed wall 734 to be moved forward, falls from the movable table 732. In addition, a plurality of physical medals G on the fixed table 731 is pressed forward by the movable table 732 and falls from the fixed table 731. Physical medals G corresponding to the quantity of physical medals G that have fallen from the fixed table 731 are paid out by the payout device 723. It should be noted that a numerical value corresponding to the quantity of physical medals G that have fallen from the fixed table 731 may be added to the credits for the user.

A front surface of the movable table 732 is provided with a plurality of lottery holes 735. Some of the plurality of physical medals G that have fallen from a surface of the movable table 732 enter a lottery hole 735. In response to entrance of the physical medal G into the lottery hole 735, a usual lottery is executed. The usual lottery is a lottery process of determining, by lottery, whether the user wins or loses.

The feeding apparatus 76 feeds physical medals G or special balls B to the game apparatus 73. For example, the physical medals G are fed on the movable table 732, and the special ball Bs are fed on the fixed table 731. For example, subject to a win in the usual lottery, the feeding apparatus 76 feeds the special balls B. The special balls B, together with physical medals G, are moved forward in conjunction with the reciprocation of the movable table 732 and finally fall from the fixed table 731. In addition, the feeding apparatus 76 feeds a lottery ball Ba to the lottery apparatus 74 and feeds a lottery ball Bb to the lottery apparatus 75.

The lottery apparatus 74 is a lottery mechanism used for the attribute lottery to determine one of the three types of attributes A1 to A3. Specifically, the lottery apparatus 74 is a substantially disk-shaped structure (a so-called “distributor”), which has a central portion that is lower than a peripheral portion. The lottery apparatus 74 is provided with three lottery holes H1 to H3 corresponding to the different attributes An. Each of the lottery holes Hn is a through-hole that can be entered by the lottery ball Ba. The lottery ball Ba that has been fed by the feeding apparatus 76 approaches the central portion while rolling in a circumferential direction on an upper surface of the lottery apparatus 74, and finally enters one of the three lottery holes H1 to H3. An attribute An corresponding to a lottery hole Hn, which has been entered by the lottery ball Ba, among the three lottery holes H1 to H3, is a lottery result by the lottery apparatus 74. The lottery apparatus 74 is an example of an “attribute lottery executor.”

The lottery apparatus 75 is a lottery mechanism used for the preliminary lottery. Specifically, the lottery apparatus 75 is provided with a lottery hole Hb that can be entered by the lottery ball Bb. The lottery ball Bb that has been fed by the feeding apparatus 76 gradually approaches the lottery hole Hb while swinging on an upper surface of the lottery apparatus 75, and finally enters the lottery hole Hb.

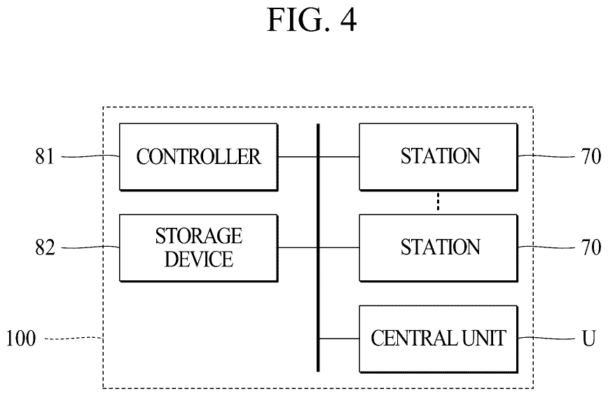

FIG. 4 is a block diagram showing the game system 100. As shown in FIG. 4, the game system 100 according to this embodiment includes a controller 81 and a storage device 82 in addition to the plurality of stations 70 and the central unit U.

The controller 81 is constituted of one or more processors configured to control each element of the game system 100. Specifically, the controller 81 may be constituted of one or more types of processors such as a central processing unit (CPU), a graphics processing unit (GPU), a digital signal processor (DSP), a field programmable gate array (FPGA), or an application specific integrated circuit (ASIC). It should be noted that some or all of the functions of the controller 81 may be provided in each of the stations 70.

The storage device 82 comprises one or more memories configured to store a program to be executed by the controller 81, and a variety of types of data to be used by the controller 81. The storage device 82 is constituted of, for example, a known recording medium such as a semiconductor recording medium or a magnetic recording medium, or a combination of different types of recording media. It should be noted that a portable recording medium that is detachable from the game system 100 may be used as the storage device 82. In addition, a recording medium (for example, a cloud storage server), which can be written to or can be read from via a communication network, may be used as the storage device 82. The storage device 82 stores a quantity of credits possessed by the user, for example. In addition, the storage device 82 stores a provisional reward quantity Jn for special rewards, for each of the attributes An.

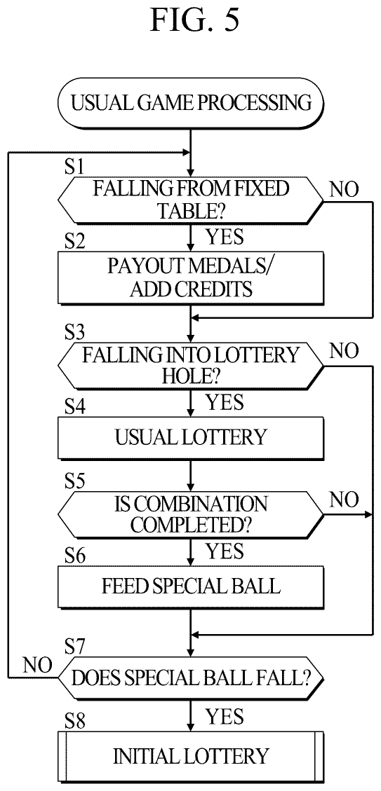

FIG. 5 is a flowchart showing processing (hereinafter, referred to as “usual game processing”) executed by the controller 81 in the usual game. The respective stations 70 repeat the usual game processing in parallel.

When the usual game processing starts, the controller 81 determines whether a physical medal G falls from the fixed table 731 (S1). When the physical medal G falls (S1: YES), the controller 81 controls the payout device 723 to execute payout of a predetermined quantity of physical medals G (S2). It should be noted that as described above, the controller 81 may add a numerical value to the credits possessed by the user. When no physical medal G falls (S1: NO), payout of physical medals G or addition for credits (S2) is not executed.

The controller 81 determines whether a physical medal G falls into a lottery hole 735 of the movable table 732 (S3). When the physical medal G falls into the lottery hole 735 (S3: YES), the controller 81 executes the usual lottery (S4). The usual lottery is a lottery process of determining whether the user wins or loses.

The usual lottery is, for example, a video slot machine. The controller 81 determines whether a combination of specific patterns is completed in the usual lottery (S5). When the combination of specific patterns is completed (S5: YES), the controller 81 controls the feeding apparatus 76 to feed a special ball B to the game apparatus 73 (S6). When no physical medal G falls into a lottery hole 735 (S3: NO), the usual lottery (S4) and feeding of the special ball B (S6) are not executed.

The controller 81 determines whether a special ball B falls from the fixed table 731 (S7). When the special ball B falls (S7: YES), the controller 81 executes the initial lottery (S8). A specific procedure for the initial lottery will be described below. When no special ball B falls (S7: NO), the controller 81 shifts processing to step S1 without executing the initial lottery.

### Lottery Unit U1

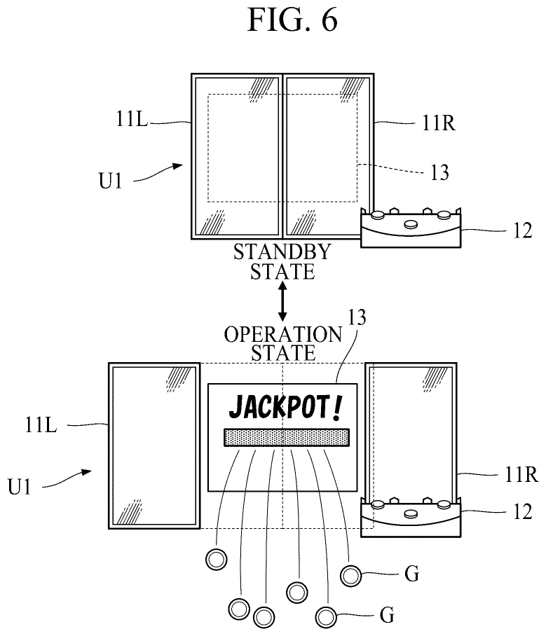

FIG. 6 is a front view of the lottery unit U1 used for the first special lottery for the attribute A1. As shown in FIG. 6, the lottery unit U1 includes a display 11L, a display 11R, and a selection apparatus 12.

The display 11L and the display 11R are constituted of, for example, display panels such as liquid crystal panels or organic EL panels, and display a variety of types of images under the control of the controller 81. The display 11L and the display 11R are movable in a horizontal direction. Specifically, the lottery unit U1 is controlled to change from being in one among the states, consisting of a standby state in which the display 11L and the display 11R are adjacent to each other and an operation state in which the display 11L and the display 11R are spaced apart from each other, to being in the other state. A feeding apparatus 13, which is disposed behind the display 11L and the display 11R in the standby state, is exposed between the display 11L and the display 11R in the operation state. When a result of the special lottery is a win, the feeding apparatus 13 feeds, as the special rewards, a large quantity of physical medals G to the game apparatus 73. In the operation state, the display 11R is disposed behind the selection apparatus 12.

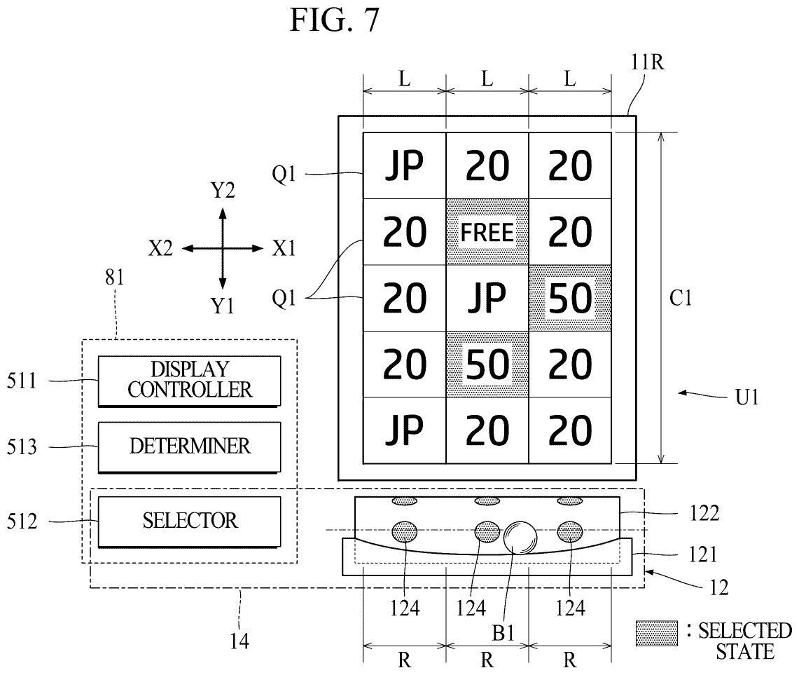

FIG. 7 is an explanatory diagram showing the first special lottery in which the lottery unit U1 is used. As shown in FIG. 7, the controller 81 executes the program stored in the storage device 82 to implement a plurality of functions (a display controller 511, a selector 512, a determiner 513) for executing the first special lottery.

The display controller 511 displays images on the display 11L and on the display 11R. For example, the display controller 511 displays, on the display 11L, rules of the first special lottery and a reward quantity J1 for the first special lottery.

In addition, as shown in FIG. 7, the display controller 511 displays, on the display 11R, a lottery card C1, which is to be used for the first special lottery. The lottery card C1 is a bingo card in which a plurality of squares Q1 are arranged. In the first special lottery, one of the plurality of squares Q1 in the lottery card C1 is sequentially selected.

As shown in FIG. 7, in a display surface of the display 11R, an X-axis and a Y-axis are set perpendicular to each other. The X-axis is a virtual axis along the horizontal direction, and the Y axis is a virtual axis along a vertical direction. The plurality of squares Q1 are arranged in a matrix of five rows along the X-axis and three columns along the Y-axis. In the following, an arrangement of five squares Q1 along the Y-axis is referred to as a “display column L.” In other words, the lottery card C1 is constituted of three display columns L arranged in the direction of the X-axis. It should be noted that the number of squares Q1 constituting each of the display columns L and the number of display columns L constituting the lottery card C1 may be freely changed. The Y-axis is an example of a “first axis,” and the X-axis is an example of a “second axis.”

The display controller 511 sets the squares Q1 individually to a selected state or a non-selected state. The selected state is a state in which a square Q1 is selected. The non-selected state is a state in which a square Q1 is not selected. In an initial stage immediately after the first special lottery starts, a square Q1 among the plurality of squares Q1 of the lottery card C1 is set to the selected state (hereinafter referred to as a “free square Q1”), and the other squares Q1 are set to the non-selected state. It should be noted that the number of free squares Q1 is freely selected.

On each of the plurality of squares Q1, a reward quantity is displayed. Each time a square Q1 is selected, a corresponding reward quantity is increased stepwise. For example, the reward quantity for each of the squares Q1 is set to “20” in an initial state, and each time a square Q1 is selected, a corresponding reward quantity is increased stepwise in the order of “20”, “50”, and “100”.

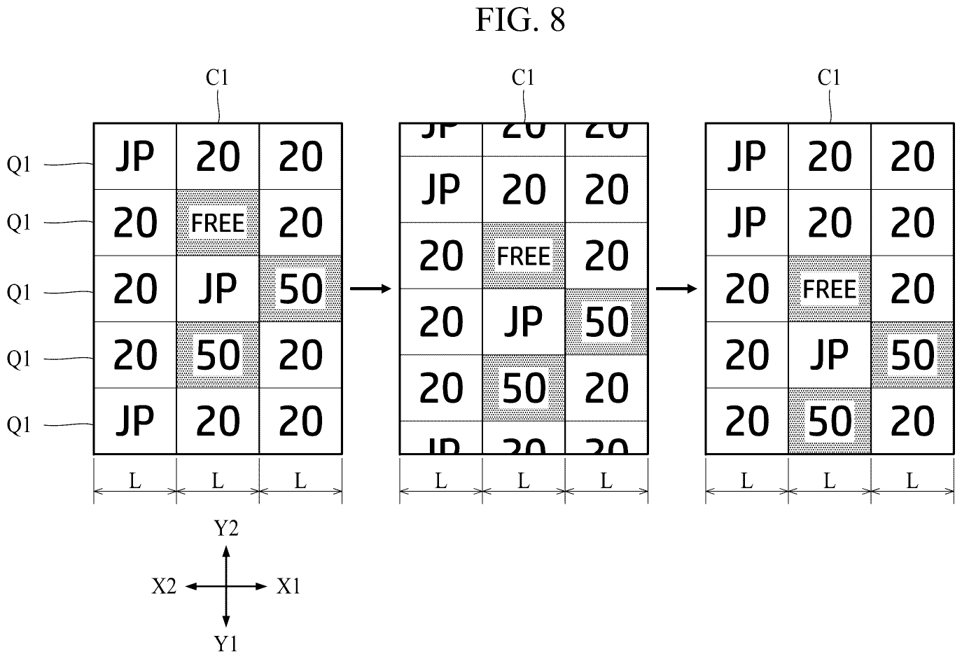

FIG. 8 is an explanatory diagram relating to the lottery card C1. As shown in FIG. 8, during execution of the first special lottery, the display controller 511 moves the plurality of squares Q1 in a direction Y1 along the Y-axis. The direction Y1 is a downward direction in the vertical direction. In other words, the respective display columns L are moved in the direction Y1. In FIG. 8, a direction Y2 is an opposite direction of the direction Y1. In other words, the direction Y2 is an upward direction in the vertical direction.

The display controller 511 moves squares Q1, each of which has reached an end in the direction Y1, among the plurality of squares Q1, to an end in the direction Y2. In other words, each of the squares Q1 that has reached the end in the direction Y1 is not displayed, and each of the squares Q1 is displayed again at the end in the direction Y2 while maintaining the state (the selected state or the non-selected state). For each of the squares Q1, “not displayed” denotes that a display of each of the squares Q1 is turned off or each of the squares Q1 is masked by another display element so as not to be visible to the user.

More specifically, with movement of a square Q1, which moves in the direction Y1, to the outside of a display area of the lottery card C1 over time, a display of a part of the square Q1 reaching the outside of the display area is not displayed, and the part of the square Q1 is displayed on an end of the display area in the direction Y2. In other words, within the display area, each of the display columns L cyclically moves in the direction Y1. As will be understood from the above description, the display controller 511 according to this embodiment displays, on the display 11R, all of the plurality of squares Q1 constituting the lottery card C1 in a manner that is simultaneously visible to the user. In other words, all of the plurality of squares Q1 are displayed in parallel (in other words, simultaneously), there is no square Q1 that is not displayed among the plurality of squares Q1.

As will be understood from the above description, among the five squares Q1 constituting each of the plurality of display columns L of the lottery card C1, two squares Q1 disposed at opposite ends from each other in a direction of the Y-axis, are considered as adjacent squares Q1. In other words, among the five squares Q1 constituting a display column L, a square Q1 disposed at the end in the direction Y1 and a square Q1 disposed at the end in the direction Y2 are spaced apart from each other in an actual display by the display 11R, but are processed as adjacent squares Q1 under the control in the first special lottery.

In FIG. 7, the selection apparatus 12 is a lottery mechanism for selecting one from the three display columns L of the lottery card C1. Specifically, the selection apparatus 12 according to this embodiment selects a display column L by conveying a lottery ball B1 to one of three target points P corresponding to the different display columns L. In other words, among the three display columns L, a display column L corresponding to a target point P reached by the lottery ball B1, is selected.

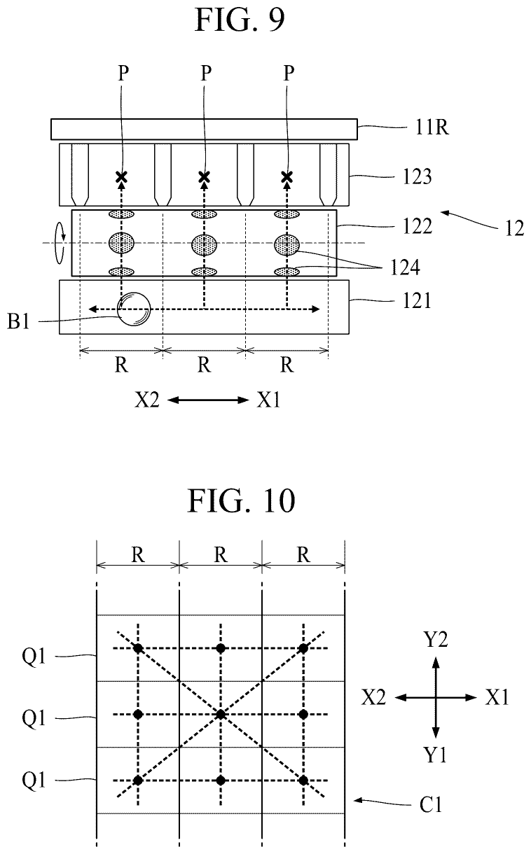

FIG. 9 is a plan view of the selection apparatus 12. As shown in FIG. 7 and FIG. 9, the selection apparatus 12 includes a waiting path 121, a rotor 122, and a target path 123. The waiting path 121 is a path for causing the lottery ball B1 to swing in the direction of the X-axis. A central portion of the waiting path 121 is lower than both end portions. Thus, the lottery ball B1 having been fed to the waiting path 121 swings in the direction of the X-axis.

The rotor 122 is a cylindrical structure that rotates about an axis along the X-axis. An outer peripheral surface of the rotor 122 is divided into three regions R corresponding to the different display columns L. Each of the regions R of the rotor 122 is provided with a plurality of holders 124 along a circumferential direction. A holder 124 is configured to hold the lottery ball B1. Specifically, a permanent magnet is provided in one or both of the holder 124 and the lottery ball B1, and the lottery ball B1 is to be held in the holder 124 by magnetic force of the permanent magnet.

As shown by an arrow in dashed line in FIG. 9, the lottery ball B1 having been swinging on the waiting path 121 is held by a holder 124 in one of the three regions R, and is conveyed by the rotation of the rotor 122 from the waiting path 121 to the target path 123.

The target path 123 is a path provided with the three target points P corresponding to the different display columns L. The three target points P are arranged at intervals along the X-axis. Each of the target points P is within an area for one of the three regions R of the rotor 122. Thus, the lottery ball B1 has been held by a holder 124 in a respective region R reaches a target point P corresponding to the region R among the three target points P. The lottery ball B1, which has reached the target point P, is detected by a detection device (not shown). A display column L corresponding to the target point P at a time at which the lottery ball B1 reaches the target point P is selected.

In FIG. 7, the selector 512 selects one from the five squares Q1 of the display column L selected by the selection apparatus 12. Specifically, the selector 512 selects, from among the five squares Q1 of the display column L, a square Q1 disposed at a bottom of the display area at a time of selection by the selection apparatus 12.

As will be understood from the above description, the selection apparatus 12 and the controller 81 (selector 512) constitutes a lottery executor 14 configured to repeatedly select one or more from among the plurality of squares Q1 of the lottery card C1 by lottery. In other words, by a combination of the selection apparatus 12 and the controller 81, the lottery executor 14 for selecting one or more from among the plurality of squares Q1 is realized. The selection apparatus 12 is an example of a “first selector,” and the selector 512 is an example of a “second selector.”

In FIG. 7, the determiner 513 determines whether a predetermined condition, which relates to the state (the selected state or the non-selected state) of each the plurality of squares Q1 of the lottery card C1, is satisfied. Specifically, the determiner 513 determines whether a line of three squares Q1 that are in the selected state (hereinafter referred to as a “line”) is completed. As described above, the determiner 513 according to this embodiment considers two squares Q1, which are disposed at opposite ends from each other in the direction of the Y-axis, in each of the plurality of display columns L, as adjacent squares Q1, and determines whether one or more lines are completed. The completion of one or more lines causes a win in the first special lottery.

FIG. 10 is an explanatory diagram showing determination by the determiner 513. As shown in FIG. 10, in the lottery card C1, lines along the X-axis in the display columns L, lines along the Y-axis, and a line along each of directions (in other words, diagonal directions) inclined relative to the X-axis and to the Y-axis may be completed. The determiner 513 determines whether a line in a direction, which is any one of the directions described above, is completed.

As shown in FIG. 7 and FIG. 8, the display controller 511 changes display appearance of a square Q1 (hereinafter referred to as a “target square Q1”) among the plurality of squares Q1 of the lottery card C1 from a usual appearance to a special appearance, wherein when the square Q1 is selected by the lottery executor 14, a line is completed. Specifically, the display controller 511 changes a display of the target square Q1 from a state in which a reward quantity is displayed, to a state in which letters “JP (jackpot)” are displayed. The letters “JP” mean a win in the first special lottery. According to the above configuration, it is possible for the user to visually and intuitively understand a square Q1 that should be selected by lottery for completion of a line. The state, in which the reward quantity is displayed on a square Q1, is an example of a “first appearance,” and the state, in which the letters “JP” are displayed on a square Q1, is an example of a “second appearance.”

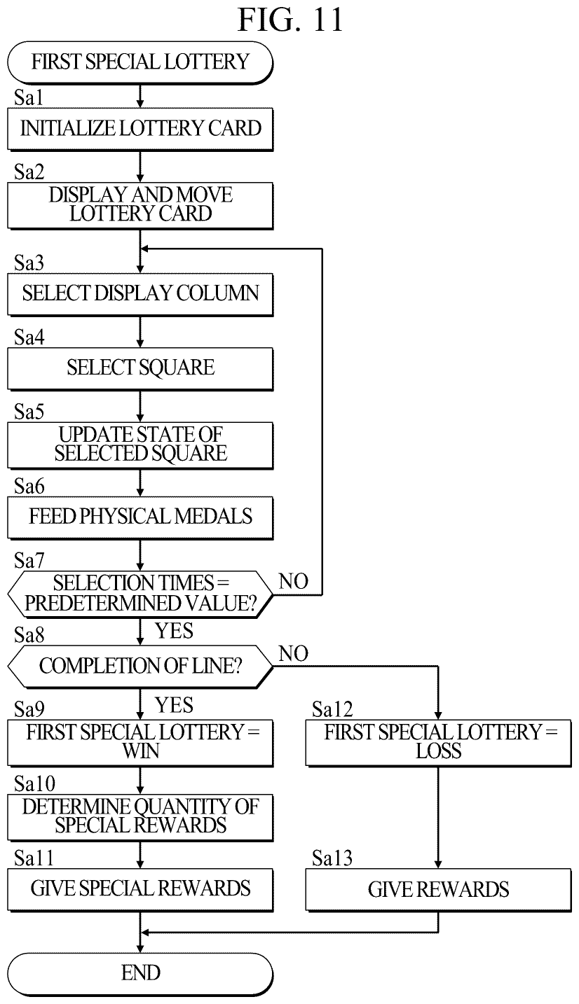

FIG. 11 is a flowchart showing the first special lottery. As described above, when the attribute A1 is selected in the attribute lottery and when a result of the preliminary lottery is a win, the first special lottery starts.

When the first special lottery starts, the controller 81 initializes the lottery card C1 (Sa1). Specifically, a reward quantity on each of the squares Q1 of the lottery card C1 is set to an initial value (20), and one of the plurality of squares Q1 is set to the selected state. The square Q1 to be set to the selected state may be selected randomly from among the plurality of squares Q1, or may be selected randomly from a specific display column L (for example, a central display column L). The controller 81 (display controller 511) displays the lottery card C1 on the display 11R, and moves each of the display columns L in the direction Y1 (Sa2). It should be noted that initialization of the lottery card C1 (Sa1) may be omitted. In other words, the state of the lottery card C1 in the last first special lottery may be maintained in the current first special lottery.

The controller 81 provides the selection apparatus 12 with an instruction to select a display column L (Sa3). In response to the instruction from the controller 81, the selection apparatus 12 feeds the lottery ball B1 to the waiting path 121 and conveys the lottery ball B1 to select one from the three display columns L.

As described above, the controller 81 (selector 512) selects, from among the five squares Q1 in the display column L selected by the selection apparatus 12, a square Q1 disposed at the bottom at a time of the selection (Sa4). The controller 81 (display controller 511) updates the state of the selected square Q1 (Sa5).

For example, when a square Q1 that is in the non-selected state is selected, the square Q1 is changed to be in the selected state. When a square Q1 that is in the selected state is selected, the reward quantity for the square Q1 is increased. When the free square Q1 is selected, selection of a square Q1 in the lottery card C1 (Sa3,Sa4) is executed again. In addition, when the selection causes a waiting state in which selection of one square Q1 is required to complete a line, the controller 81 (display controller 511) changes the display appearance of the target square Q1.

The controller 81 provides the feeding apparatus 76 with an instruction to feed a reward quantity of physical medals G, corresponding to the selected square Q1 (Sa6). Thus, the physical medals G corresponding to the reward quantity for the selected square Q1 are fed to the game apparatus 73. In addition, the controller 81 adds the reward quantity corresponding to the selected square Q1 to the reward quantity J1 of special rewards stored in the storage device 82. It should be noted that in the above description, a configuration is described in which physical medals G are fed to the game apparatus 73 each time a square Q1 is selected; however, the reward quantity for the selected square Q1 may be sequentially accumulated each time selection is executed. After the end of the first special lottery, a quantity of physical medals G corresponding to the final accumulated value is fed by the feeding apparatus 76 to the game apparatus 73, regardless of a win or a loss in the first special lottery.

The controller 81 determines whether the number of times that a square Q1 is selected in the lottery card C1 reaches a predetermined value (Sa7). The predetermined value is, for example, “4.” When the number of selection times is less than the predetermined value (Sa7: NO), the controller 81 shifts processing to step Sa3. In other words, in parallel with movement of the respective display columns L, selection of a square Q1 is repeated by the lottery executor 14.

When the number of selection times reaches the predetermined value (Sa7: YES), the controller 81 determines whether one or more lines are completed in the lottery card C1 (Sa8). In this embodiment, a square Q1 is initially set to the selected state, and selection of a square Q1 is repeated by the lottery executor 14 four times. Thus, for example, a case may occur in which two lines are completed that are constituted of different combinations of squares Q1 in a display column L.

When one or more lines are completed (Sa8: YES), a result of the first special lottery is a win (Sa9). The controller 81 determines a quantity of special rewards for the win in the first special lottery (Sa10). Specifically, the controller 81 determines the quantity of special rewards in accordance with the reward quantity J1 stored in the storage device 82 and a total number of lines completed in the lottery card C1. For example, a value obtained by multiplying the reward quantity J1 and the total number of lines together is determined to be the quantity of special rewards. A numerical value corresponding to the total number of completed lines may be added to the reward quantity J1.

The controller 81 gives the user the quantity of special rewards determined through procedures described above (Sa11). Specifically, the controller 81 controls the feeding apparatus 13 to feed the quantity of physical medals G to the game apparatus 73.

On the other hand, when no line is completed in the lottery card C1 (Sa8: NO), the result of the first special lottery is a loss (Sa12). When the result of the first special lottery is a loss, the controller 81 controls the feeding apparatus 76 to feed a predetermined quantity of physical medals G to the game apparatus 73. A reward quantity at a time of a loss is less than the quantity for the special rewards. The first special lottery procedure is as described above.

As described above, in the first special lottery, two squares Q1 disposed at opposite ends from each other in the direction of the Y-axis are considered as adjacent squares Q1, and it is determined whether an arrangement (in other words, a line) of a predetermined number of squares Q1 that are in the selected state is completed. In other words, compared to a configuration in which two squares Q1 disposed at opposite ends from each other are not considered as adjacent squares Q1, it is possible to increase a chance of completion of a line. Thus, it is possible to maintain a user's expectation of completion of a line over a long period.

In this embodiment, the plurality of squares Q1 displayed on the display 11R is moved along the Y-axis; thus, two adjacent squares Q1 along the Y-axis are displayed in a state in which the two squares Q1 are disposed at opposite ends from each other in the direction of the Y-axis (in other words, a state considered as adjacent squares Q1) or in a state in which the two squares Q1 are actually adjacent to each other in the direction of the Y-axis. Thus, it is easy for the user to visually understand that two squares Q1 in the selected state are adjacent to each other along the direction of the Y-axis. In particular, according to this embodiment, in a state in which all of the plurality of squares Q1 are displayed in parallel on the display 11R, each of the plurality of squares Q1 is moved in the direction of the Y-axis. Thus, the user can visually and intuitively understand a state in which each of the plurality of squares Q1 is adjacent to another one in the direction of the Y-axis.

In addition, according to this embodiment, in a configuration in which the plurality of squares Q1 is moved in the direction Y1, a square Q1 is selected that is placed at a specific position at a time at which the selection apparatus 12 selects a display column L. Thus, it is easy for the user to visually understand a square Q1 that is to be selected from among the plurality of squares Q1 displayed on the display 11R.

### Lottery Unit U2

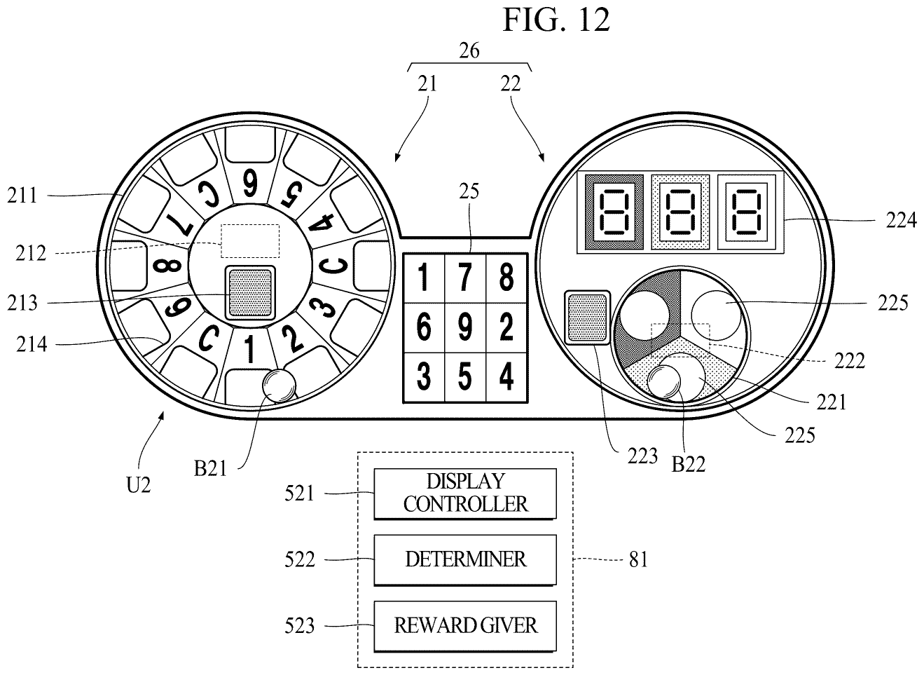

FIG. 12 is a front view of the lottery unit U2 used for the second special lottery for the attribute A2. As shown in FIG. 12, the lottery unit U2 includes a display 25 and a lottery mechanism 26. The lottery mechanism 26 includes a lottery apparatus 21 and a lottery apparatus 22. The lottery apparatus 21 and the lottery apparatus 22 are arranged to be spaced apart from each other in the horizontal direction, and the display 25 is provided between the lottery apparatus 21 and the lottery apparatus 22. The display 25 is constituted of, for example, a display panel such as a liquid crystal panel or an organic EL panel, and displays images under the control of the controller 81. The lottery mechanism 26 is an example of a “lottery executor.”

The lottery apparatus 21 is a physical lottery mechanism for selecting one from a plurality of options. The plurality of options includes a plurality of usual options and a plurality of special options (C). Each of the plurality of usual options is one among nine numbers from “1” to “9.”

The lottery apparatus 21 includes a lottery board 211, a drive device 212, and a feeding apparatus 213. The lottery board 211 is a rotatable disc-shaped member about an axis along the horizontal direction. In a vicinity of an outer peripheral edge of the lottery board 211, a plurality of lottery holes 214 corresponding to different options is provided. Specifically, the lottery board 211 is provided with nine lottery holes 214 corresponding to the different usual options and three lottery holes 214 corresponding to the special options. It should be noted that the three lottery holes 214 corresponding to the special options are spaced apart from one another in a circumferential direction.

The drive device 212 is a motor for rotating the lottery board 211. The feeding apparatus 213 feeds a lottery ball B21 onto the lottery board 211. The lottery ball B21 is fed by the feeding apparatus 213 in parallel with a rotation of the lottery board 211 made by the drive device 212. Thus, the lottery ball B21 falls along a board surface of the lottery board 211, and finally enters one of the plurality of lottery holes 214. Among the plurality of options, an option (usual option or special option) corresponding to a lottery hole 214 entered by the lottery ball B21 is a lottery result achieved by the lottery apparatus 21.

The lottery apparatus 22 is a physical lottery mechanism for selecting one from three numbers (hereinafter referred to as “candidate values”), and includes a lottery board 221, a drive device 222, a feeding apparatus 223, and a display 224. The display 224 is a seven-segment display capable of displaying the three candidate values. The three candidate values displayed by the display 224 can be changed. It should be noted that the display 224 may be constituted of a display panel such as a liquid crystal panel or an organic EL panel.

The lottery board 221 is a rotatable disc-shaped member about an axis along the horizontal direction. In a vicinity of a peripheral edge of the lottery board 221, a plurality of lottery holes 225 corresponding to the different candidate values displayed on the display 224 is provided. In other words, the respective lottery holes 225 of the lottery board 221 and the respective candidate values displayed on the display 224 are in one-to-one correspondence with each other.

The drive device 222 is a motor for rotating the lottery board 221. The feeding apparatus 223 feeds a lottery ball B22 onto a board surface of the lottery board 221. The lottery ball B22 is fed by the feeding apparatus 223 in parallel with a rotation of the lottery board 221 made by the drive device 222. Thus, the lottery ball B22 falls along the board surface of the lottery board 221, and finally enters one of the plurality of lottery holes 225. Among the plurality of candidate values, a candidate value corresponding to a lottery hole 225 entered by the lottery ball B22 is a lottery result achieved by the lottery apparatus 22.

As shown in FIG. 12, the controller 81 executes the program stored in the storage device 82 to implement a plurality of functions (a display controller 521, a determiner 522, a reward giver 523) for executing the second special lottery.

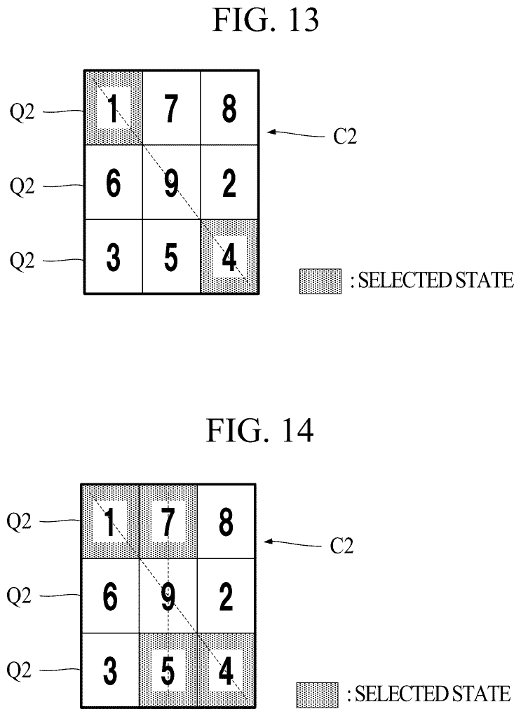

The display controller 521 displays images on the display 25. Specifically, the display controller 521 displays a lottery card C2, which is to be used for the second special lottery, on the display 25. As shown in FIG. 13 and FIG. 14, the lottery card C2 is a bingo card in which a plurality of squares Q2 corresponding to the different usual options are arranged in a matrix of three rows and three columns. In other words, a usual option that is a numerical value from “1” to “9” is assigned to one of the plurality of squares Q2. It should be noted that a total number of squares Q2 constituting the lottery card C2, and the arrangement of the squares Q2 in the lottery card C2 may be freely changed.

The display controller 521 sets the squares Q2 individually to a selected state or a non-selected state. The selected state is a state in which a square Q2 is selected. The non-selected state is a state in which a square Q2 is not selected. In an initial stage immediately after the second special lottery starts, two squares Q2 among the plurality of squares Q2 of the lottery card C2 are set to the selected state (a so-called free state), and the other squares Q2 are set to the non-selected state.

In FIG. 12, the determiner 522 determines whether a predetermined winning condition is satisfied in the lottery card C2. The winning condition is a condition relating to an arrangement of two or more squares Q2 in the selected state among the plurality of squares Q2 of the lottery card C2. Specifically, the winning condition is that an arrangement (a line) of three squares Q2 in the selected state is completed in the lottery card C2. As will be understood from FIG. 13 and FIG. 14, in the lottery card C2, lines along the vertical direction, lines along the horizontal direction, and a line along each of the diagonal directions may be completed. The determiner 522 determines whether a line in a direction among the directions described above is completed. The reward giver 523 gives the user special rewards when the winning condition is satisfied.

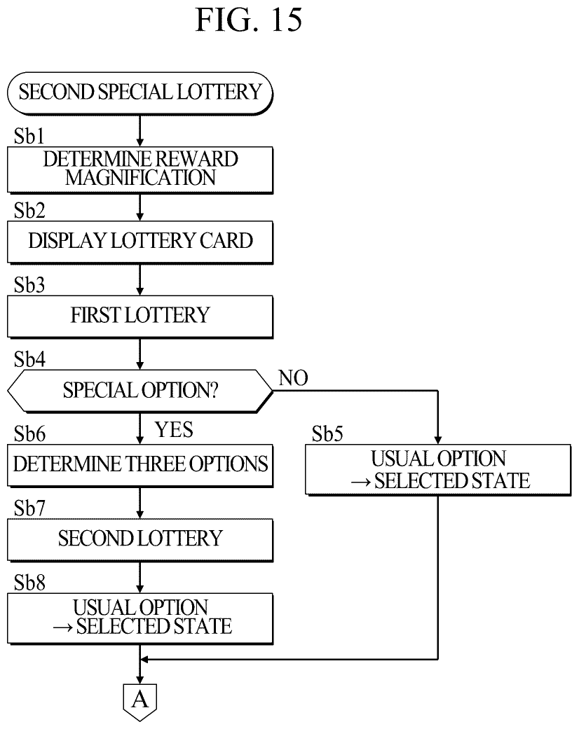

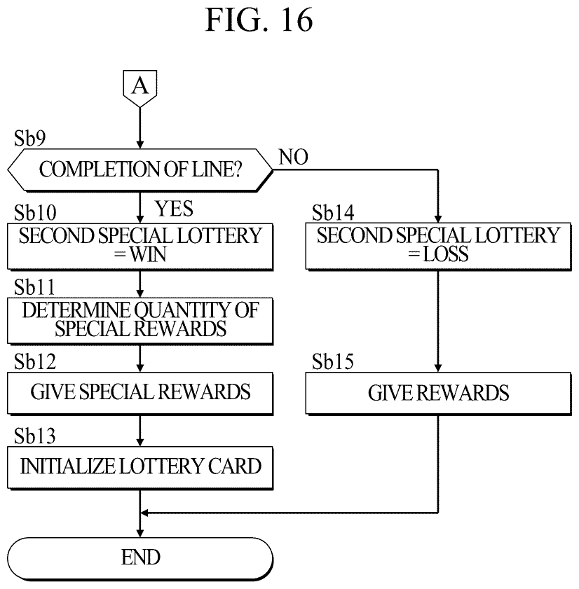

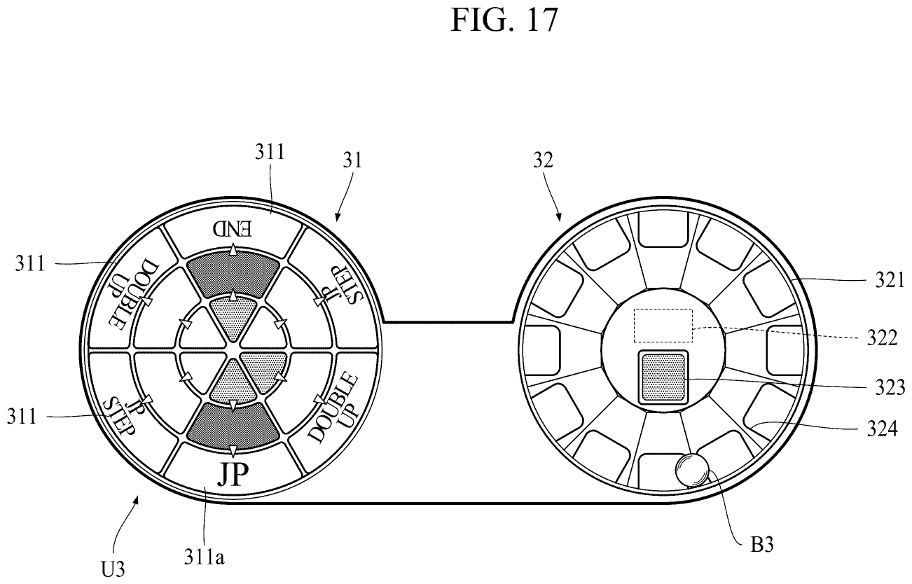

FIG. 15 and FIG. 16 are flowcharts showing the second special lottery. As described above, when the attribute A2 is selected in the attribute lottery and when a result of the preliminary lottery is a win, the second special lottery starts.

When the second special lottery starts, the controller 81 controls the lottery apparatus 22 to determine a reward increase a (Sb1). Specifically, while displaying three candidate values relating to the reward increase a on the display 224, the controller 81 causes the feeding apparatus 223 to feed the lottery ball B22. The three candidate values are different numerical values. However, two candidate values among the three candidate values may be the same. The controller 81 sets, as the reward increase a, a candidate value corresponding to a lottery hole 225 entered by the lottery ball B22 among the plurality of lottery holes 225 of the lottery board 221.

The controller 81 (display controller 521) displays the lottery card C2 constituted of the plurality of squares Q2 on the display 25 (Sb2). In an initial lottery card C2, two squares Q2 among the plurality of squares Q2 are set to the selected state, and the other squares Q2 are set to the non-selected state. Specifically, in the initial lottery card C2, two squares Q2 that are to be initially set to the selected state are determined such that when a square Q2 is changed from being in the non-selected state to being in the selected state, a line between the two squares Q2 in the selected state is completed. In other words, the initial lottery card C2 is in a waiting state in which a line is completed when a square Q2 is set to the selected state. It should be noted that in the initial lottery card C2, the number of squares Q2 set to the selected state is not limited to two. For example, in the initial lottery card C2, one or three or more squares Q2 may be set to the selected state; alternatively, all of the squares Q2 in the initial lottery card C2 may be set to the non-selected state.

The controller 81 causes the lottery apparatus 21 to execute the first lottery to select one from the plurality of options (Sb3). Specifically, the controller 81 causes the feeding apparatus 213 of the lottery apparatus 21 to feed the lottery ball B21. Under the control of the controller 81, the lottery apparatus 21 executes the first lottery to select one from the plurality of options including the plurality of usual options and the plurality of special options.

The controller 81 determines whether the option selected by the first lottery is a special option (Sb4). When a usual option is selected by the first lottery (Sb4: NO), the controller 81 (display controller 521) sets a square Q2 corresponding to the usual option selected by the first lottery among the plurality of squares Q2 of the lottery card C2, to the selected state (Sb5).

On the other hand, when a special option is selected by the first lottery (Sb4: YES), the controller 81 causes the lottery apparatus 22 to execute the second lottery (Sb6 to Sb8). The second lottery is a lottery process of selecting one from three usual options among the nine usual options that are selection candidates for the first lottery. In other words, the number (3) of usual options that are selection candidates for the second lottery is less than the number (9) of usual options that are the selection candidates for the first lottery. Thus, a probability that a target option is selected in the second lottery is greater than a probability that the target option is selected in the first lottery. As described above, in this embodiment, the number of usual options that are the selection candidates for the second lottery is less than the number of usual options that are the selection candidates for the first lottery. Thus, it is possible to realize a state in which the probability that the target option is selected in the second lottery is greater than the probability that the target option is selected in the first lottery.

The controller 81, first, determines the three usual options that are to be the selection candidates for the second lottery (Sb6). The three usual options that are to be the selection candidates for the second lottery include the target option. The target option is a usual option that causes the winning condition to be satisfied when selected from among the plurality of usual options. In other words, the target option is a usual option that causes a line to be completed when the target option is selected. Thus, the target option is a usual option corresponding to a square Q2 in the non-selected state among the plurality of squares Q2 of the lottery card C2. According to the configuration described above, by the target option being selected in the second lottery, the state of the square Q2 corresponding to the target option is changed from the non-selected state to the selected state. In other words, the game using the plurality of squares Q2 progresses. Thus, it is possible to give the user the expectation of satisfaction of the winning condition.

In FIG. 13, it is assumed that a usual option “1” of the first row and the first column and a usual option “4” of the third row and the third column are in the selected state. In a state described above, when a usual option “9” of the second row and the second column is set to the selected state, a line of “1”, “9”, and “4” is completed in a diagonal direction. Thus, the controller 81 sets, as the target option, a usual option “9” to a candidate for the second lottery.

When a result of the second special lottery is a loss, the state of the lottery card C2 is maintained in the next second special lottery. In FIG. 14, a state is shown in which a usual option “7” of the first row and the second column and a usual option “5” of the third row and the second column, in addition to the two usual options (in other words, “1” and “4”) shown in FIG. 13, are in the selected state. In the state shown in FIG. 14, for example, when a usual option “8” of the first row and the third column is set to the selected state, a line of “1”, “7”, and “8” is completed in the horizontal direction. Similarly, for example, when a usual option “3” of the third row and the first column is set to the selected state, a line of “3”, “5”, and “4” is completed in the horizontal direction.

On the other hand, in the state shown in FIG. 14, for example, when a usual option “9” of the second row and the second column is set to the selected state, a line of “1”, “9”, and “4” in the diagonal direction and a line of “7”, “9”, and “5” in the vertical direction are completed at the same time. In other words, by selection of the usual option “9”, two lines are completed. In the state shown in FIG. 14, the controller 81 sets the usual option “9” as a target option. In other words, a usual option that can cause two or more lines that are constituted of different combinations of squares Q2 to be completed, is set as a target option. In addition, the controller 81 further sets, as a target option, a usual option that can cause one or more lines to be completed when the usual option is selected. In other words, the controller 81 further sets, as a target option, a usual option “8” or “3” in addition to the usual option “9.” As described above, two target options are included in the selection candidates for the second lottery.

In addition, the three usual options that are the selection candidates for the second lottery include a usual option, which causes the winning condition not to be satisfied when the usual option is selected by the second lottery, among the nine usual options. For example, in the state shown in FIG. 13, no line is completed when any one among six usual options of “7”, “8”, “6”, “2”, “3”, and “5” is selected. Thus, the controller 81 causes the three usual options, which are the selection candidates for the second lottery, to include one of the six usual options of “7”, “8”, “6”, “2”, “3”, and “5.” In addition, for example, in the state shown in FIG. 14, no line is completed when any one among two usual options of “6” and “2” is selected. Thus, the controller 81 causes the three usual options, which are the selection candidates for the second lottery, to include one of the two usual options of “6” and “2.”

As described above, the three usual options to be selected by the second lottery include a usual option that causes the winning condition not to be satisfied when the usual option is selected. In other words, as a result of the second lottery, a case in which the winning condition is satisfied or a case in which the winning condition is not satisfied may occur. Thus, it is easy to maintain interest in the game compared to a configuration in which the winning condition is always satisfied as a result of the second lottery. However, a configuration is assumed in which each of the three usual options that are the selection candidates for the second lottery is a usual option that causes the winning condition to be satisfied when the usual option is selected. According to the configuration described above, when any one of the three usual options is selected by the second lottery, the winning condition is satisfied.

When determining the three usual options through the above-described procedure, the controller 81 causes the lottery apparatus 22 to execute the second lottery to select one from among the three usual options (Sb7). Specifically, the controller 81 displays, as candidate values, the three usual options on the display 224 of the lottery apparatus 22, and causes the feeding apparatus 223 to feed the lottery ball B22. The lottery apparatus 22 executes the second lottery to select one from among the three usual options including the one or more target options.

As will be understood from the above description, the lottery apparatus 22 is used for the lottery (Sb1) to determine the reward increase a and is used for the second lottery (Sb7). The controller 81 (display controller 521) sets, to the selected state, a square Q2 corresponding to a usual option selected by the second lottery, among the plurality of squares Q2 of the lottery card C2 (Sb8).

As will be understood from the above description, the lottery mechanism 26 executes the first lottery and the second lottery. The lottery mechanism 26 according to this embodiment includes the lottery apparatus 21 for executing the first lottery and the lottery apparatus 22 for executing the second lottery. In other words, in this embodiment, each of the first lottery and the second lottery is executed by a different lottery apparatus. Thus, compared to a configuration in which a common lottery apparatus is used for the first lottery and is used for the second lottery, it is possible to provide a variety of games that are very interesting. However, the first lottery and the second lottery may be executed by a common lottery apparatus. It should be noted that the lottery apparatus 21 is an example of a “first lottery apparatus,” and the lottery apparatus 22 is an example of a “second lottery apparatus.”

When updating the state of the lottery card C2 through the above-described procedure, as shown in FIG. 16, the controller 81 (determiner 522) determines whether the winning condition is satisfied in the updated lottery card C2 (Sb9). In other words, the controller 81 determines whether the winning condition is satisfied in a result of selection of a usual option in the first lottery or in the second lottery. Specifically, it is determined whether one or more lines are completed in the updated lottery card C2.

When the winning condition is satisfied (Sb9: YES), a result of the second special lottery is a win (Sb10). The controller 81 (reward giver 523) determines a quantity of special rewards for the win in the second special lottery (Sb11). Specifically, the controller 81 determines the quantity of special rewards in accordance with a reward quantity J2 stored in the storage device 82, the reward increase a determined by the lottery (Sb1), and a total number of lines completed in the lottery card C2. For example, a value obtained by multiplying the reward quantity J2, the reward increase a, and the total number of lines together is determined to be the quantity of special rewards. The total number of lines completed in the lottery card C2 is the number (satisfaction number) of times that the winning condition is satisfied in the second special lottery. As will be understood from the above description, the controller 81 (reward giver 523) gives the user rewards corresponding to the number of times that the winning condition is satisfied.

The controller 81 gives the user the quantity of special rewards determined through the above-described procedure (Sb12). Specifically, the controller 81 controls the feeding apparatus 13 to provide the game apparatus 73 with a determined quantity of physical medals G. In addition, the controller 81 initializes the lottery card C2 (Sb13).

As described above, in the state shown in FIG. 14, when the usual option “8” or “3” is selected, one line is completed. On the other hand, when the usual option “9” is selected, two lines are completed. Thus, a quantity of special rewards determined in a case in which the usual option “9” is selected is greater than a quantity of special rewards in a case in which the usual option “8” or “3” is selected. In this embodiment, a usual option that causes a large quantity of special rewards, which is given to the user when the winning condition is satisfied, is preferentially selected as a target option. In other words, the controller 81 selects a target option from among the plurality of usual options in descending order of values of rewards, which are given to the user when the winning condition is satisfied. Thus, it is possible to give the user the expectation of acquiring a large quantity of rewards.

On the other hand, when the winning condition is not satisfied (Sb9: NO), the result of the second special lottery is a loss (Sb14). The controller 81 controls the feeding apparatus 76 to provide the game apparatus 73 with a predetermined quantity of physical medals G. When the result of the second special lottery is a loss, the lottery card C2 is not initialized. In other words, the lottery card C2 is maintained in the current state and is used in the next second special lottery.

As described above, in the second special lottery, when a special option is selected from among the plurality of options, the second lottery is executed that causes a target option, which contributes to the satisfaction of the winning condition, to be selected with high probability compared to the first lottery. Thus, the user not only expects satisfaction of the winning condition caused by selection of a usual option in the first lottery, but also expects satisfaction of the winning condition caused by selection of the target option with high probability in the second lottery when a special option is selected. In other words, compared to a configuration in which one of the plurality of usual options is simply selected by lottery, it is possible to provide a highly entertaining game that causes a user's expectation of satisfaction of the winning condition to be maintained.

In particular, according to this embodiment, a square Q2 corresponding to a usual option selected by the first lottery or by the second lottery is set to the selected state, and it is determined whether the winning condition is satisfied in an arrangement of two or more squares Q2 that are in the selected state. Thus, the user can visually or intuitively understand, in accordance with the arrangement of the plurality of squares Q2, whether the winning condition is satisfied.

Furthermore, in this embodiment, a usual option, which causes a plurality of lines to be completed when selected, is set to a selection candidate for the second lottery as a target option. Thus, it is possible to give the user the expectation of satisfaction of the winning condition in a plurality of lines.

### Lottery Unit U3

FIG. 17 is a front view of the lottery unit U3 used for the third special lottery for the attribute A3. As shown in FIG. 17, the lottery unit U3 includes a display 31 and a lottery apparatus 32. The display 31 is constituted of, for example, a display panel such as a liquid crystal panel or an organic EL panel, and displays various images under the control of the controller 81.

The lottery apparatus 32 is a physical lottery mechanism for selecting one from a plurality of options. The lottery apparatus 32 includes a lottery board 321, a drive device 322, and a feeding apparatus 323. The lottery board 321 is a rotatable disc-shaped member about an axis along the horizontal direction. In a vicinity of an outer peripheral edge of the lottery board 321, a plurality of lottery holes 324 is provided. Each of the plurality of lottery holes 324 corresponds to one of the plurality of options. The lottery board 321 is provided with one or more lottery holes 324 for each of the plurality of options.

The drive device 322 is a motor for rotating the lottery board 321. The feeding apparatus 323 feeds a lottery ball B3 onto a board surface of the lottery board 321. The lottery ball B3 is fed by the feeding apparatus 323 in parallel with a rotation of the lottery board 321 made by the drive device 322. Thus, the lottery ball B3 falls along the board surface of the lottery board 321, and finally enters one of the plurality of lottery holes 324. Among the plurality of options, an option corresponding to a lottery hole 324 entered by the lottery ball B3 is a lottery result achieved by the lottery apparatus 32. A numerical value corresponding to an option selected by the lottery apparatus 32 is added to a reward quantity J3 stored in the storage device 82.

A lottery, in which the lottery ball B3 is fed to select one from among the plurality of lottery holes 324, as described above, is repeated until a predetermined termination condition is satisfied. The termination condition includes, for example, a condition that the reward quantity J3 reaches a predetermined value, or a condition in which the lottery ball B3 enters a specific lottery hole 324 (termination pocket) among the plurality of lottery holes 324. However, when a predetermined number of lottery balls B3 having been fed at the beginning of the third special lottery enters the specific lottery hole 324, the termination condition is not satisfied.

The controller 81 displays a plurality of options 311 on the display 31. In each of the plurality of options 311, a stage sequentially progresses each time selection is executed by the lottery apparatus 32, and when the selection is executed by the lottery apparatus 32 three times, a final stage is reached. When a specific option 311a among the plurality of options 311 reaches the final stage, a result of the third special lottery is a win. The reward quantity J3 is increased each time the option 311a is further selected after the win. On the other hand, when the option 311a does not reach the final stage until the above-described termination condition is satisfied, the result of the third special lottery is a loss.

When the result of the third special lottery is a win, the controller 81 gives the user a quantity of special rewards corresponding to the reward quantity J3 stored in the storage device 82. Specifically, the controller 81 controls the feeding apparatus 13 to feed the reward quantity J3 of the physical medals G to the game apparatus 73. It should be noted that the plurality of options includes an option (JP step) to progress the stage of the option 311a when the final stage is reached, and an option (DOUBLE UP) to start a lottery game to double a quantity of special rewards when the final stage is reached.

### Preliminary Lottery

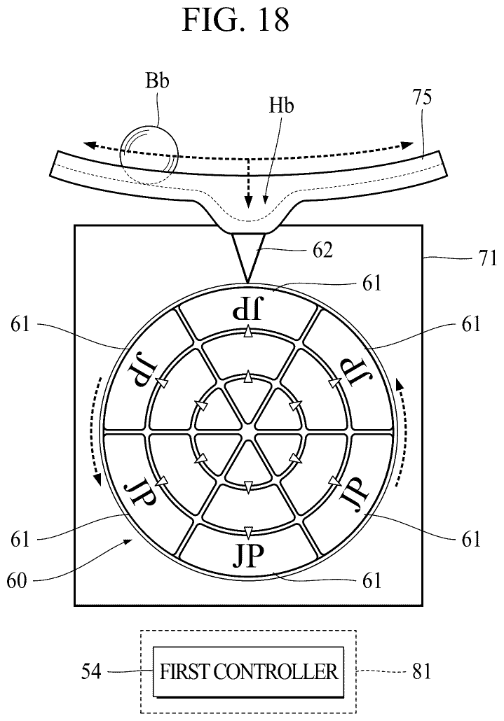

FIG. 18 is an explanatory diagram showing the preliminary lottery shown in FIG. 2. As shown in FIG. 18, for the preliminary lottery, the display 71 and the lottery apparatus 75 in each of the plurality of stations 70 is used. As described above, the lottery ball Bb that has been fed by the feeding apparatus 76 to the lottery apparatus 75 gradually approaches the lottery hole Hb while swinging on the upper surface of the lottery apparatus 75, and finally enters the lottery hole Hb.

As shown in FIG. 18, the controller 81 executes the program stored in the storage device 82 to realize a first controller 54 for controlling the preliminary lottery.

The first controller 54 displays a lottery image 60 and an indication image 62 on the display 71. The lottery image 60 is a circular image including a plurality of options 61. The plurality of options 61 are fan-shaped images arranged circumferentially. Central angles of the respective options 61 are the same. The first controller 54 rotates the lottery image 60. The indication image 62 is an image for indicating a specific position in a circumferential direction of the lottery image 60. In other words, one of the plurality of options 61 is indicated by the indication image 62. It should be noted that a total number of options 61 constituting the lottery image 60 is freely selected. In addition, a configuration in which the central angles of the respective options 61 differ, or a configuration in which each of the central angles of the respective options 61 is dynamically changed, is assumed.

The first controller 54 selects one from among the plurality of options 61 of the lottery image 60 in accordance with movement of the lottery ball Bb in the lottery apparatus 75. Specifically, the first controller 54 selects, from among the plurality of options 61 of the lottery image 60, an option 61 indicated by the indication image 62 at a time at which the lottery ball Bb falls into the lottery hole Hb of the lottery apparatus 75. In other words, by a combination of the lottery apparatus 75, the display 71, and the controller 81 (first controller 54), a “first lottery executor” for selecting one from among the plurality of options 61 is realized.

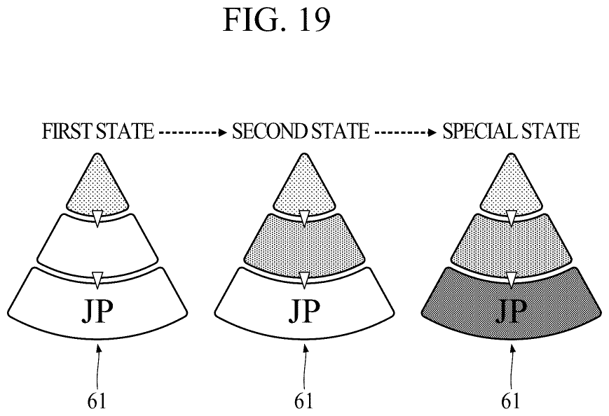

FIG. 19 is an explanatory diagram relating to each of the plurality of options 61. A state of each of the plurality of options 61 changes stepwise each time selection is executed in the preliminary lottery. Specifically, a respective option 61 of the plurality of options 61 is changed from being in an initial first state to being in an intermediate second state when selected once, and is changed from being in the second state to being in a special state when selected twice. In other words, the respective option 61 is changed stepwise until the special state each time the respective option 61 is selected by the first controller 54. Thus, the plurality of options 61 to be selected by the preliminary lottery includes an option 61 in the first state, an option 61 in the second state, and an option 61 in the special state. By the respective option 61 being changed stepwise until the special state, options 61 in the special state are increased among the plurality of options 61. In this embodiment, each time the respective option 61 is selected in the preliminary lottery, the state of the respective option 61 is changed stepwise from the first state to the special state. Thus, the user can understand a process of increasing the number of options 61 in the special state.

As will be understood from the above description, the preliminary lottery is a lottery process of selecting one from among the plurality of options 61 including an option 61 in the special state. When the option 61 in the special state is selected in the preliminary lottery, the special lottery starts. In other words, the option 61 in the special state is a lottery element that is a start condition for the special lottery. It should be noted that the number of stages of the state of an option 61 is not limited to the above example (three stages), and it may be freely changed.

The plurality of options 61 are managed individually for each of the attributes An. Specifically, the state of each of the plurality of options 61 is stored in the storage device 82 for each of the attributes An. For example, state data indicative of states (first state, second state, special state) of the plurality of options 61 is stored individually in the storage device 82 for each of the attributes An. Thus, the number of options 61 in the special state (hereinafter referred to as “the number of special options K”) among the plurality of options 61 is an individual number for each of the attributes An.

It should be noted that in an initial lottery image 60, one or more options 61 among the plurality of options 61 (for example, one option 61) are set to the special state, and the other options 61 are set to the first state. However, for example, in the initial lottery image 60, all of the options 61 may be set to the first state. In addition, in addition to the option 61 to be changed to be in the special state, an option 61 corresponding to a specific reward may be included in the lottery image 60. For example, when a specific option 61 is selected from among the plurality of options 61, the feeding apparatus 76 may feed the special ball B to the game apparatus 73.

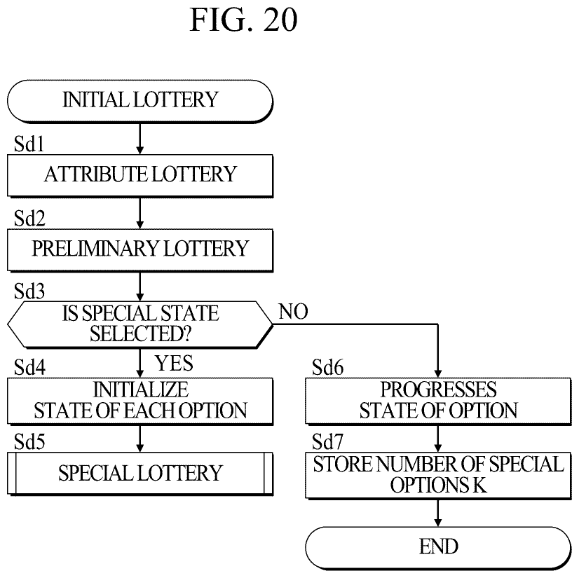

FIG. 20 is a flowchart showing the initial lottery. As described above, the initial lottery starts in response to the special ball B falling (S7: YES) in the usual game processing (FIG. 5).

When the initial lottery starts, the controller 81 selects one from among the three types of attributes A1 to A3 by the attribute lottery in which the lottery apparatus 74 is used (Sd1). Specifically, the controller 81 provides the feeding apparatus 76 with an instruction to feed the lottery ball Ba to the lottery apparatus 74, and selects an attribute An corresponding to a lottery hole Hn into which the lottery ball Ba falls at the lottery apparatus 74.

After executing the attribute lottery, the controller 81 executes the preliminary lottery (Sd2). First, the controller 81 (first controller 54) displays, on the display 71, a lottery image 60 corresponding to the attribute (hereinafter referred to as a “selected attribute”) An, selected by the attribute lottery, and rotates the lottery image 60. The state (first state, second state, special state) of each of the plurality of options 61 in the lottery image 60 is set in accordance with the state data for the selected attribute An. Then, the controller 81 (first controller 54) provides the feeding apparatus 76 with an instruction to feed the lottery ball Bb to the lottery apparatus 75, and selects, from among the plurality of options 61, an option 61 indicated by the indication image 62 at a time at which the lottery ball Bb falls into the lottery hole Hb. As will be understood from the above description, the preliminary lottery is a process of selecting one from among the plurality of options 61 each of which is in the state, which is stored in the storage device 82, for the selected attribute An.

The controller 81 (first controller 54) determines whether an option 61 in the special state is selected in the preliminary lottery (Sd3). The determination result is affirmative when the option 61 in the special state is selected, or is negative when an option 61 in the first state or in the second state is selected. When the option 61 in the special state is selected (Sd3: YES), the controller 81 initializes the state of each of the plurality of options 61 for the selected attribute An (Sd4). It should be noted that a case in which the option 61 in the special state is selected (Sd3: YES) means a win in the preliminary lottery.

When the option 61 in the special state is selected (Sd3: YES), the controller 81 executes a special lottery corresponding to the selected attribute An (Sd5). Specifically, the first special lottery shown in FIG. 11 is executed when the attribute A1 is selected, the second special lottery shown in FIG. 15 and FIG. 16 is executed when the attribute A2 is selected, and the third special lottery is executed when the attribute A3 is selected. As described above, in this embodiment, the preliminary lottery and the special lottery are individually managed for each of the plurality of attributes An. Thus, various game developments are realized in accordance with the result of the attribute lottery.

On the other hand, when the option 61 in the special state is not selected in the preliminary lottery (Sd3: NO), the controller 81 progresses the state of the option 61 selected in the preliminary lottery (Sd6). Specifically, when the option 61 in the first state is selected in the preliminary lottery, the controller 81 changes the option 61 from being in the first state to being in the second state. In addition, when the option 61 in the second state is selected in the preliminary lottery, the controller 81 changes the option 61 from being in the second state to an option 61 in the special state. The controller 81 stores the number of special options K for the changed lottery image 60 in the storage device 82 (Sd7). The number of special options K is stored in the storage device 82 individually for each of the attributes An.

As will be understood from the above description, when the option 61 in the special state is not selected by the preliminary lottery, the controller 81 (first controller 54) increases the option 61 in the special state among the plurality of options 61. It should be noted that in a case in which the option 61 in the special state is not selected (Sd3: NO) means a loss in the preliminary lottery. In other words, a loss in the preliminary lottery causes the number of special options K to increase.

When the option 61 in the special state is not selected by the preliminary lottery (Sd3: NO), the state of each of the plurality of options 61 for the selected attribute An is not initialized. In other words, the state of the lottery image 60 for each of the plurality of attributes An is maintained in the next preliminary lottery. Thus, the number of special options K is cumulatively increased each time the preliminary lottery is executed, until the option in the special state is selected.

### Additional Lottery

As described above, when the option in the special state is selected by the preliminary lottery, the special lottery is executed by the central unit U (lottery unit Un). In addition, when the result of the special lottery is a win, the additional lottery is executed for determining a quantity of additional rewards. As described above, when the option 61 in the special state is selected by the preliminary lottery and when a condition is satisfied in that a result of the special lottery is a win, the additional lottery is executed. A case in which the result of the special lottery in a win is an example of a “predetermined condition.”

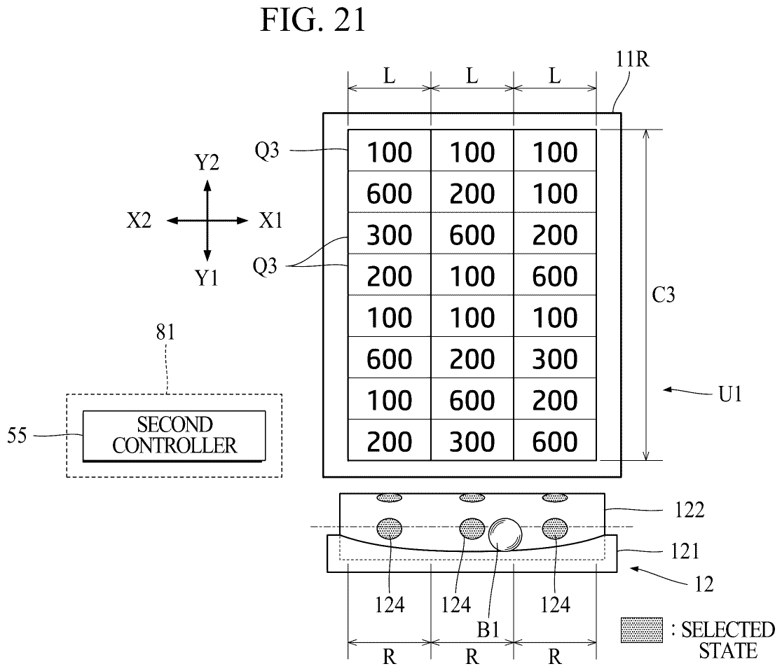

FIG. 21 is an explanatory diagram showing the additional lottery. As shown in FIG. 21, the lottery unit U1 is used for the additional lottery. Specifically, in a state in which the lottery unit U1 faces a station 70 for a user who wins the special lottery, the additional lottery is executed. As described above, the lottery unit U1 is used for the first special lottery and is used for the additional lottery. However, each of the first special lottery and the additional lottery may be executed by a different lottery apparatus.

As shown in FIG. 21, the controller 81 executes the program stored in the storage device 82 to realize a second controller 55 for executing the additional lottery.

The second controller 55 displays a reward card C3 for determining a quantity of additional rewards on the display 11R. The reward card C3 is constituted of a plurality of squares Q3 arranged in a matrix of eight rows along the X-axis and three columns along the Y-axis. In other words, a display column Lis constituted of a line of eight squares Q3 along the Y-axis, and three display columns L are arranged in the direction of the X-axis. On each of the plurality of squares Q3 of the reward card C3, a reward quantity is set individually. During execution of the additional lottery, the second controller 55 moves the plurality of squares Q3 of the reward card C3 in the direction Y1. In other words, the respective display columns L are moved in the direction Y1. It should be noted that the number of squares Q3 constituting each of the display columns L and the number of display columns L constituting the reward card C3 may be freely changed.

The additional lottery includes a unit lottery to be executed M times (M is a natural number of one or more). The unit lottery is a lottery process of determining a quantity of additional rewards to be given to the user. Specifically, in the unit lottery, one of the plurality of squares Q3 of the reward card C3 is selected. The reward quantity that is set to the square Q3 selected from the reward card C3 is a result of the unit lottery. The quantity of additional rewards is a total value of the reward quantity determined by the unit lottery executed M times.

A procedure for selecting a square Q3 from the reward card C3 in the unit lottery is similar to a procedure for selecting a square Q1 from the lottery card C1 in the first special lottery. Specifically, the selection apparatus 12 selects one from among the three display columns L of the reward card C3, and the second controller 55 selects one from among the eight squares Q3 of the display column L selected by the selection apparatus 12. Specifically, the second controller 55 selects, from among the eight squares Q3 of the display column L, a square Q3 disposed at a specific position (for example, a bottom of the display area) at a time of the selection by the selection apparatus 12. As will be understood from the above description, the selection apparatus 12, the display 11R, and the controller 81 (second controller 55) function as a “second lottery executor” for executing the additional lottery.

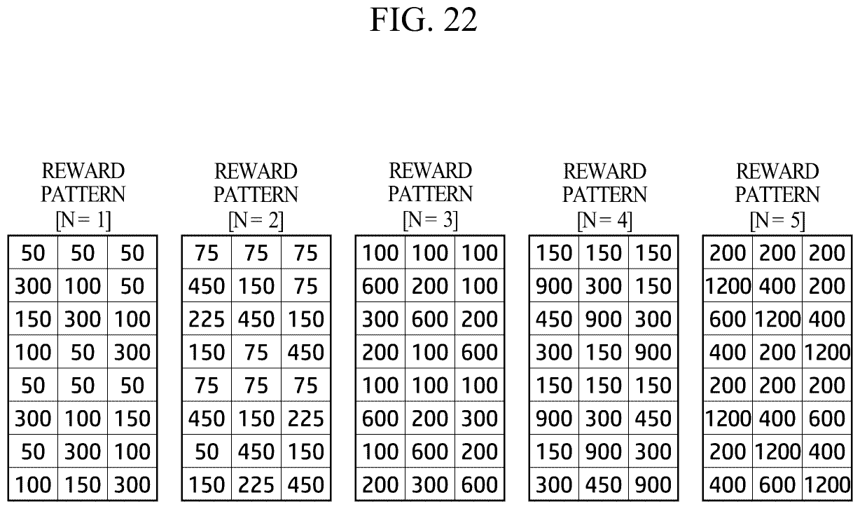

The storage device 82 stores a plurality of reward patterns and a control table. FIG. 22 is a schematic diagram showing the plurality of reward patterns. For each of a plurality of identification numbers N (N=1 to 5), a reward pattern is stored. An identification number N is a number for identifying one of the plurality of reward patterns.

As shown in FIG. 22, each of the plurality of reward patterns is data for specifying a reward quantity for each of the plurality of squares Q3 of the reward card C3. The reward quantity specified for each of the plurality of squares Q3 differs between the reward patterns. The first controller 54 sets the reward quantity for each of the plurality of squares Q3 by use of one of the plurality of reward patterns stored in the storage device 82.

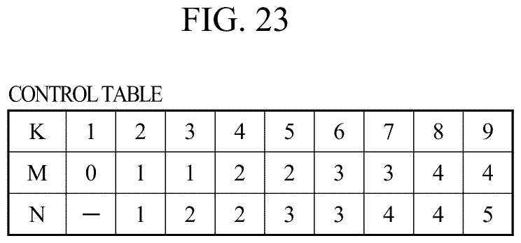

FIG. 23 is a schematic diagram showing the control table. The control table is a data table to be applied to control of the additional lottery. As shown in FIG. 23, in the control table, for each of a plurality of numerical values (K=1, 2 . . . 9) possible to be indicated by the number of special options K, the number of lottery times M and the identification number N are set.

The number of lottery times M is the number of times that the unit lottery is executed per additional lottery. The identification number N specifies one of the reward patterns stored in the storage device 82. In other words, one of the plurality of reward patterns is specified for each numerical value of the number of special options K. It should be noted that, for example, in response to an instruction of a manager of the game system 100, the number of lottery times M or the identification number N corresponding to each numerical value of the number of special options K may be changed. It is possible to adjust a payout rate by changing the number of lottery times M or the identification number N.

The second controller 55 searches the control table for the number of lottery times M and the identification number N corresponding to the number of special options K for the selected attribute An stored in the storage device 82. The second controller 55 repeats a unit lottery, to which a reward pattern for the identification number N corresponding to the number of special options K among the plurality of reward patterns is applied, M times, where M is the number of lottery times M corresponding to the number of special options K. In other words, the second controller 55 controls the number of lottery times M for the unit lottery and the quantity of additional rewards in the additional lottery in accordance with the number of special options K. As will be understood from the above description, the second controller 55 executes the additional lottery in accordance with the number of special options K.

A numerical value of the number of lottery times M in the control table is set in accordance with a numerical value of the number of special options K. Specifically, the numerical value of the number of lottery times M is increased with an increase in the numerical value of the number of special options K. However, for different numerical values of the number of special options K, a value of the number of lottery times M may be registered.

Similarly, a numerical value of the identification number N is set in accordance with a numerical value of the number of special options K. Specifically, the numerical value of the identification number N is increased with an increase in the numerical value of the number of special options K. However, for different numerical values of the number of special options K, a value for the identification number N may be registered. As shown in FIG. 22, with an increase in the identification number N of the reward pattern, each of the reward quantities registered in the reward pattern is increased. Thus, the greater the numerical value of the number of special options K, the greater the reward quantities registered in the reward pattern.

As shown in FIG. 23, the number of lottery times M corresponding to the numerical value “1” of the number of special options K is “0”, and the identification number N is not set. The second controller 55 does not execute the additional lottery when the number of special options K is less than or equal to “1.” In other words, the second controller 55 executes the additional lottery when the number of special options K is greater than a predetermined threshold Kt. The threshold Kt is, for example, “1.”

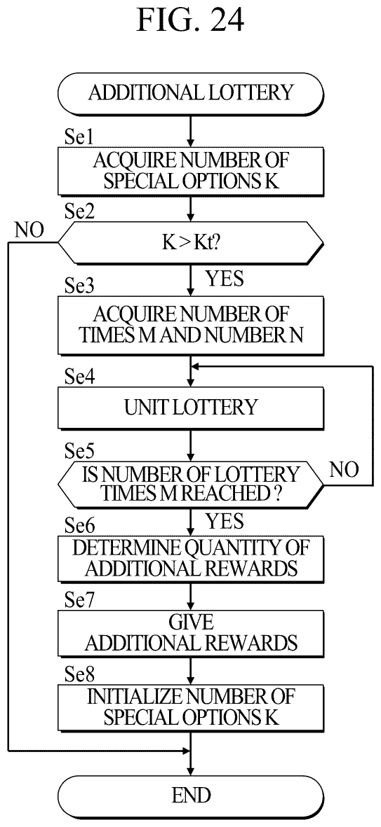

FIG. 24 is a flowchart showing the additional lottery. As described above, the additional lottery starts in response to a win in the special lottery. For example, the additional lottery is executed in parallel with an effect operation to give the user the special rewards.

When the additional lottery starts, the controller 81 (second controller 55) acquires the number of special options K for the selected attribute An stored in the storage device 82 (Se1). The controller 81 (second controller 55) determines whether the number of special options K is greater than the threshold Kt (Se2). The threshold Kt is, for example, “1.” When the number of special options K is less than or equal to the threshold Kt (Se2: NO), the controller 81 terminates the additional lottery without executing subsequent processing (Se3 to Se8).

On the other hand, when the number of special options K is greater than the threshold Kt (Se2: YES), the controller 81 (second controller 55) executes the additional lottery (Se3 to Se5). Specifically, first, the controller 81 acquires the number of lottery times M and the identification number N corresponding to the number of special options K from the control table (Se3). The controller 81 determines the reward quantity by a unit lottery to which the reward pattern for the identification number N is applied (Se4). The unit lottery is repeated M times, where M is the number of lottery times M (Se5: NO).

When the number of times that the unit lottery is executed reaches the number of lottery times M (Se5: YES), the controller 81 (second controller 55), determines the quantity of additional rewards (Se6). Specifically, a total value of the reward quantity determined by the unit lottery executed M times is set as the quantity of additional rewards. The controller 81 (second controller 55) gives the user the quantity of additional rewards determined through the above-described procedure (Se7). Specifically, the controller 81 controls the feeding apparatus 13 to feed the quantity of physical medals G to the game apparatus 73. In addition, the controller 81 initializes the number of special options K for the selected attribute An into the number of options 61 in the special state (for example, “1”) set at an initial stage (Se8).

As described above, in this embodiment, when an option 61 in the special state is not selected in the preliminary lottery, the option 61 in the special state is increased. Thus, a possibility that the option 61 in the special state is selected in a subsequent preliminary lottery increases. In addition, after the option 61 in the special state is selected in the preliminary lottery, the additional lottery dependent on the number of special options K is executed. In other words, a result of selecting no option 61 in the special state in the preliminary lottery affects the additional lottery. As described above, even when the option 61 in the special state is not selected in the preliminary lottery, it is possible to maintain an expectation that the option 61 in the special state will be selected in a subsequent preliminary lottery, and furthermore, it is possible to maintain an expectation that the additional lottery dependent on the number of special options K well be executed. Thus, compared to a configuration in which the number of special options K is fixed in the preliminary lottery or a configuration in which the additional lottery is not executed, even when no option 61 in the special state is selected in the preliminary lottery (in other words, in a case of a loss in the preliminary lottery), it is possible to prompt the user to continue the game.

In particular, according to this embodiment, the number of times M that the unit lottery is executed in the additional lottery is controlled in accordance with the number of special options K. Thus, even when no option 61 in the special state is selected in the preliminary lottery, it is possible to effectively provide incentives for the user to continue the game. In addition, the quantity of additional rewards, which is to be given to the user in accordance with a result of the additional lottery, is controlled in accordance with the number of special options K. Thus, even when no option 61 in the special state is selected in the preliminary lottery, it is possible to effectively provide incentives for the user to continue the game.

In this embodiment, whether the additional lottery is executed is controlled in accordance with the number of special options K. Thus, even when no option 61 in the special state is selected in the preliminary lottery, it is possible to effectively provide incentives for the user to continue the game.

In addition, the special lottery is executed when the option 61 in the special state is selected in the preliminary lottery, and the additional lottery is executed subject to a win in the special lottery. Thus, the user can expect, in addition to special rewards to be given to the user due to a win in the special lottery, rewards due to the additional lottery being executed in accordance with the number of special options K.

### Modifications

Each of the embodiments described above may be variously modified. Examples of specific modifications that may be applied to the above embodiments will be described below. Two or more modifications freely selected from the following modifications may be combined as long as no conflict arises from such combination.

(1) In the foregoing embodiment, a configuration is described in which two squares Q1 disposed at opposite ends from each other in the direction of the Y-axis are considered as adjacent squares Q1; however, a configuration is assumed in which two squares Q1 disposed at opposite ends from each other in the direction of the X-axis are considered as adjacent squares Q1. In other words, among two or more squares Q1 aligned in the direction of the X-axis at each of locations on the Y-axis, a square Q1 disposed at the end in the direction X1 and a square Q1 disposed at the end in the direction X2 are considered as adjacent squares Q1.

In the above-described configuration, two squares Q1 disposed at opposite ends from each other in the direction of the Y-axis are considered as being adjacent to each other, and furthermore, two squares Q1 disposed at opposite ends from each other in the direction of the X-axis are considered as being adjacent to each other. According to the above-described configuration, compared to a configuration in which two squares Q1 disposed at the opposite ends from each other in the direction of the X-axis are not considered as being adjacent to each other, it is possible to increase the chance of completion of a line of a predetermined number of squares Q1 in the selected state. Thus, it is possible to maintain a user's expectation of completion of a line in the lottery card C1 over a long period.

(2) In the foregoing embodiment, a configuration is described in which when the free square Q1 is selected in the first special lottery, selection of a square Q1 is executed again; however, processing to be executed in a case in which the free square Q1 is selected is not limited to the above example. For example, a configuration in which the number of times that a lottery is executed in the first special lottery increases, or a configuration in which rewards are given to the user, is assumed. In addition, a quantity of rewards given to the user in a case in which the free square Q1 is selected may be a predetermined value determined in advance, or may be determined by lottery. The rewards are typically given by feeding physical medals G to the game apparatus 73; however, the type of rewards given in a case in which the free square Q1 is selected is not limited to the above example. For example, the special ball B may be fed to the game apparatus 73 as rewards. Alternatively, processing to progress a state of one of the plurality of options 61 in the lottery image 60 may be given to the user as rewards.

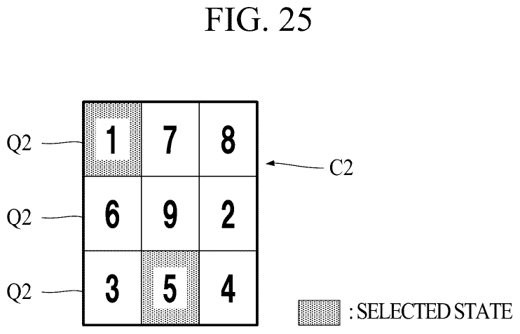

(3) In the foregoing embodiment, a usual option that can cause one or more lines to be completed when the usual option is selected in the second special lottery is set as a target option; however, a condition for the target option is not limited to the above example. For example, it is assumed that the initial lottery card C2 immediately after the second special lottery starts is in a state shown in FIG. 25. In the lottery card C2 shown in FIG. 25, even when any one of the usual options in the non-selected state is selected, no line is completed.

In the state shown in FIG. 25, the controller 81 selects, as the target option, a usual option that causes the total number of squares Q2, each of which causes completion of a line in the next second special lottery, to be the most numerous. For example, when “8” is selected in a current second special lottery, only a line of “1”, “7”, and “8” can be completed in the next second special lottery. On the other hand, when “9” is selected in the current second special lottery, a line of “7”, “9”, and “5” can be completed in a case in which “7” is selected in the next second special lottery, and a line of “1”, “9”, and “4” can be completed in a case in which “4” is selected. In other words, the number of squares Q2 each of which causes completion of a line in the next second special lottery is two. Thus, the controller 81 sets, as the target option, the usual option “9” to a candidate for the second lottery. According to the above-described configuration, when no line is completed in the current second special lottery, it is possible to give the user an expectation of completion of a line in the next second special lottery.

(4) In the foregoing embodiment, a configuration is described in which when an option 61 in a state (first state or second state) other than the special state is selected in the preliminary lottery, the state of the option 61 is progressed toward the special state; however, an event that triggers progress of the state of the option 61 is not limited to the selection of the option 61.

For example, in accordance with movement of the user or a state of the game apparatus 73 in a specific period (hereinafter referred to as a “preparation period”) prior to the beginning of the initial lottery, the controller 81 may progress a state of a specific option 61 among the plurality of options 61 corresponding to a specific attribute An. For example, a configuration in which the state of the option 61 is progressed in accordance with a total number of physical medals G provided by the user within the preparation period, or a configuration in which the state of the option 61 is progressed in accordance with a total number of physical medals G that entered the lottery hole 735 within the preparation period, is assumed.

It should be noted that a method for determining an option 61 having a state to be progressed is freely selected. For example, a configuration in which the states of the options 61 corresponding to an attribute An randomly selected from among the three attributes A1 to A3 are progressed, or a configuration in which a state of an option 61 randomly selected from among the plurality of options 61 corresponding to the attribute An is progressed, is assumed.

(5) In the foregoing embodiment, a configuration is described in which when the option 61 in the special state is selected in the preliminary lottery, the plurality of options 61 for the selected attribute An is initialized (Sd4); however, processing executed in a case in which the option 61 in the special state is selected is not limited to the above example. For example, a configuration in which only a state of an option 61 selected in the preliminary lottery from among the plurality of options 61 for the selected attribute An is initialized into the first state, or a configuration in which the state of the option 61 is returned from the special state to the second state, is assumed.

(6) In the foregoing embodiment, the number of special options K is counted individually for each of the three attributes A1 to A3; however, a numerical value obtained by adding together the number of options 61 in the special state for the respective three attributes A1 to A3 may be counted as the number of special options K. Alternatively, the number of special options K may be a numerical value obtained by adding together the number of options 61 in the special state for the respective stations 70.

(7) In the foregoing embodiment, a configuration is described in which when a result of the special lottery is a loss, the usual game is resumed; however, an operation executed in a case in which the result of the special lottery is a loss is not limited to the above example. For example, a configuration in which the special lottery is resumed in exchange for use of medals by the user, or a configuration in which the special lottery is resumed subject to a win in a specific lottery is assumed.

(8) Various types of lottery processes described in the foregoing embodiment may be physical lotteries realized by lottery mechanisms or may be electronic lotteries realized by the controller 81 executing arithmetic processing. Alternatively, the lottery processes may be realized by a combination of a physical lottery and an electronic lottery as in the preliminary lottery described above.

(9) In the foregoing embodiment, a configuration is described in which all the squares Q1 constituting the lottery card C1 are displayed in parallel; however, some of the plurality of squares Q1 constituting the lottery card C1 may be displayed on the display 11R. For example, squares Q1, which reach the end in the direction Y1 and are not displayed, may be displayed again at the end in the direction Y2 after a predetermined period. Similarly, in the reward card C3, some of the plurality of squares Q3 may be displayed on the display 11R.

(10) In the foregoing embodiment, the selector 512 selects a square Q1 disposed at the bottom of the display column L selected by the selection apparatus 12; however, a condition used by the selector 512 for selecting a square Q1 from the display column L is not limited to the above example. For example, the selector 512 may select a square Q1 disposed at a top of the display column L at a time of selection by the selection apparatus 12, or may select a square Q1 disposed at a middle of the display column L. In other words, the selector 512 selects, from among the plurality of squares Q1 of the display column L selected by the selection apparatus 12, a square Q1 disposed at a specific position at the time of the selection.

(11) In the foregoing embodiment, a configuration is described in which the number of usual options in the second lottery is less than the number of usual options in the first lottery; however, a configuration for realizing a state in which a probability that the target option is selected in the second lottery is greater than a probability that the target option is selected in the first lottery, is not limited to the above example. For example, a configuration is assumed in which a ratio of the number of target options to the number of usual options that are selection candidates in the second lottery is greater than a ratio of the number of target options to the number of usual options that are selection candidates in the first lottery. In the above-described configuration, even when the number of usual options in the first lottery is the same as that in the second lottery, the probability that the target option is selected in the second lottery is greater than the probability that the target option is selected in the first lottery.

(12) In the foregoing embodiment, a configuration is described in which the physical medals G are given to the user as rewards; however, a mode of the rewards given to the user is not limited to the above example. For example, tangible game values such as bills (coins) or tickets may be given as the rewards to the user. Alternatively, intangible game values such as electronic medals, credits, or points may be given as the rewards to the user. Game values used by the user and game values given as rewards to the user may be of the same type or may differ in type.

(13) In the foregoing embodiment, a configuration is described in which the game system 100 is provided in the real space; however, the game system 100 may be realized as a virtual object provided in a virtual space realized by arithmetic processing. Thus, for example, by an information apparatus such as a smartphone or a tablet terminal, a service similar to that provided by the game system 100 in the foregoing embodiment may be provided to the user. For example, a game similar to that provided by the game system 100 is realized as an application game provided by the information apparatus executing a program or as a cloud game provided by a server capable of communicating with the information apparatus.

(14) The functions of the game system 100 according to the foregoing embodiment are realized by a combination of one or more processors constituting the controller 81 and the program stored in the storage device 82. The program according to the embodiment described above may be provided in a form stored in a computer-readable recording medium and may be installed in a computer. The recording medium may be a non-transitory recording medium, and an example of the non-transitory recording medium is an optical recording medium (an optical disk) such as a compact disk read-only memory (CD-ROM), and the non-transitory recording medium may also include a recording medium of any known kind, such as a semiconductor recording medium or a magnetic recording medium. The non-transitory recording medium, which includes any recording medium except for a transitory recording medium, propagating signal, does not exclude a volatile recording medium. The non-transitory recording medium may be a storage apparatus in a distribution apparatus that stores a computer program for distribution via a communication network.

### Supplemental Notes

For example, this disclosure is understood as follows based on the above descriptions. In the following descriptions, reference signs in the drawings are denoted in parentheses for convenience in order to facilitate understanding of each aspect, but this disclosure is not limited to the aspects illustrated in the drawings.

### Supplemental Note A

There have been conventionally proposed various lottery games in which a lottery card is used in which a plurality of squares are arranged in a matrix. For example, Patent Document A (Japanese Patent No. 5790595) discloses a bingo game in which a line of five squares along a vertical direction among a plurality of squares can be moved in an up-down direction.

However, in a state in which, for example, squares selected by lotteries are dispersed throughout a lottery card, even if a line of five squares is moved as in Patent Document A, a user may think that the possibility of completion of bingo is sufficiently low; thus, there is a problem in that a user's expectation is reduced with progress of a lottery game. In view of the circumstances described above, an object of an aspect (supplement note A) of this disclosure is to maintain a user's expectation of completion of a line of a predetermined number of squares over a long period of progress of a lottery game.

### Supplemental Note A1

To solve the above problems, a game system (100) according to one aspect (supplemental note A1) of this disclosure includes a display controller (511) configured to display, on a display (11R), a lottery card (C1) including a plurality of squares (Q1) divided into a plurality of display columns (L), each of the plurality of display columns (L) including two or more squares (Q1) aligned along a first axis (Y-axis), the plurality of display columns (Q1) being arranged along a second axis (X-axis) intersecting the first axis (Y-axis), a lottery executor (14) configured to repeatedly select one or more squares (Q1) from among the plurality of squares (Q1) by lottery, and a determiner (513) configured to consider, among the two or more squares (Q1) included in each of the plurality of display columns (L) in the lottery card (C1), two squares (Q1) disposed at opposite ends from each other in a direction of the first axis (Y-axis), as adjacent squares (Q1), and determine whether a line of a predetermined number of squares (Q1) that are in a selected state is completed.

According to the aspect described above, the two squares (Q1) disposed at the opposite ends from each other in the direction of the first axis (Y-axis) are considered as adjacent squares (Q1), it is determined whether the line of the predetermined number of squares (Q1) that are in the selected state is completed. In other words, compared to a configuration in which squares (Q1) disposed at opposite ends from each other are not considered as adjacent squares (Q1), it is possible to increase a chance to complete a line of a predetermined number of squares (Q1) in the selected state. Thus, it is possible to maintain a user's expectation of completion of a line of a predetermined number of squares (Q1) over a long period.

“Square (Q1)” is a game element that is a candidate for selection by lottery, and is set to one of the plurality of states including the selected state and the non-selected state. The selected state is a state selected by lottery. The plurality of squares (Q1) may include a square (Q1) (free square), which is initially set to the selected state. The non-selected state is a state that is not selected. It should be noted that the “square (Q1)” may be set to a state other than two types of states including the selected state and the non-selected state.

“Consideration of two squares (Q1) disposed at opposite ends from each other in the direction of the first axis (Y-axis) as adjacent squares (Q1)” means that the two squares (Q1) are actually disposed at opposite ends from each other in the direction of the first axis (Y-axis), but are conveniently or virtually treated as adjacent squares (Q1) in the direction of the first axis (Y-axis). In other words, opposite ends of an arrangement of the two or more squares (Q1) aligned along the first axis (Y-axis) have a connection relation. Thus, when in a specific position in the direction of the second axis (X-axis), a predetermined number of squares (Q1), which include a square (Q1) disposed at an end in one direction along the first axis (Y-axis) and a square (Q1) disposed at an end in the other direction, are in the selected state, a result of determination by the determiner (513) is affirmative (for example, a win in a lottery game). It should be noted that the above description focuses on an arrangement of the predetermined number of squares (Q1) along the first axis (Y-axis); however, when a predetermined number of squares (Q1) including two squares (Q1) disposed at opposite ends from each other in the direction of the first axis (Y-axis) are aligned a direction intersecting the first axis (Y-axis) and the second axis (X-axis), a result of the determination is affirmative.

“Predetermined number” is a predetermined number of two or more. The “line (arrangement) of the predetermined number of squares (Q1)” basically means a straight line. Specifically, a line along the first axis (Y-axis), a line along the second axis (X-axis), or a line along the direction intersecting the first axis (Y-axis) and the second axis (X-axis) may be included in the line of the predetermined number of squares (Q1). However, the “line of the predetermined number of squares (Q1)” is not limited to a straight line, and may be a curved line, for example.

The “lottery executor (14)” means a process of randomly selecting one or more squares (Q1) from among the plurality of squares (Q1). For example, a lottery mechanism for executing a physical lottery by a mechanical mechanism, or an arithmetic device for executing an electronic lottery using an arithmetic process is given as an example of the “lottery executor (14).” The “lottery executor (14)” is a lottery mechanism provided in the real space, a lottery mechanism provided in a virtual space, or a lottery function for executing an electronic lottery through arithmetic processing by an arithmetic device. The lottery executor 14 repeatedly selects one from among the plurality of squares (Q1), for example. Two or more squares (Q1) may be selected at a time.

### Supplemental Note A2

In a specific example (supplemental note A2) of the supplemental note A1, the determiner (513) is further configured to consider, among two or more squares (Q1) aligned along the second axis (X-axis) in the lottery card C1, two squares (Q1) disposed at opposite ends from each other in a direction of the second axis (X-axis), as adjacent squares (Q1). According to the aspect described above, the two squares (Q1) disposed at the opposite ends from each other in the direction of the first axis (Y-axis) are considered as adjacent squares (Q1), and furthermore, the two squares (Q1) disposed at the opposite ends from each other in the direction of the second axis (X-axis) are considered as adjacent squares (Q1). According to the aspect described above, compared to a configuration in which the two squares (Q1) disposed at the opposite ends from each other in the direction of the second axis (X-axis) are not considered as adjacent squares (Q1), it is possible to increase a chance of completion of the line of the predetermined number of squares (Q1) in the selected state. Thus, the effect is particularly significant in that it is possible to maintain a user's expectation of completion of a line of a predetermined number of squares (Q1) over a long period.

### Supplemental Note A3

In a specific example (supplemental note A3) of the supplemental note A1 or the supplemental note A2, the display controller (511) is configured to move the plurality of squares (Q1) in a first direction (direction Y1) along the first axis (Y-axis) and move a respective square (Q1) that reaches an end in the first direction (direction Y1) among the plurality of squares (Q1) to an end in a second direction (direction Y2) opposite to the first direction (direction Y1). According to the aspect described above, the plurality of squares (Q1) displayed on the display (11R) is moved along the first axis (Y-axis); thus, two adjacent squares (Q1) along the first axis (Y-axis) are displayed in a state in which the two squares (Q1) are disposed at the opposite ends from each other in the direction of the first axis (Y-axis) (in other words, a state considered as adjacent squares (Q1)) or in a state in which the two squares (Q1) are actually adjacent to each other in the direction of the first axis (Y-axis). Thus, it is easy for the user to visually understand that two squares (Q1) in the selected state are adjacent to each other along the direction of the first axis (Y-axis).

“Movement of a respective square (Q1) that reaches an end in the first direction (direction Y1) to an end in a second direction (direction Y2)” means a process by which the square (Q1) that reaches the end in the first direction (direction Y1) is not displayed and the squares (Q1) maintains the state (the selected state or the non-selected state) and is displayed again at the end in the second direction (direction Y2). For example, with movement of a square (Q1) that reaches the end in the first direction (the direction Y1) to the outside of a display area over time, a part of the square (Q1) is displayed again on an end of the display area in the second direction (direction Y2) over time.

In a configuration in which the plurality of squares (Q1) is moved, it is not necessary to display all of the squares (Q1) constituting the lottery card (C1) in parallel on the display (11R). In other words, some of the plurality of squares (Q1) may not be temporarily displayed. For example, in a configuration in which two or more squares (Q1), which are disposed in a specific area, among all of the plurality of squares (Q1) constituting the lottery card (C1), are selectively displayed on the display (11R), the plurality of squares (Q1) may be moved relative to the area, or the area may be moved relative to the plurality of squares (Q1).

In a configuration in which some of the squares (Q1) constituting the lottery card (C1) are displayed on the display (11R), squares (Q1), which reach the end in the first direction (direction Y1) and are not displayed, are displayed again at the end in the second direction (direction Y2) after a predetermined period. For example, squares (Q1) of the plurality of squares (Q1), which are moved from the display area in the first direction (direction Y1), are virtually moved by a predetermined distance, and are displayed again at an end of the display area in the second direction (direction Y2). On the other hand, in a configuration in which all of the plurality of squares (Q1) constituting the lottery card (C1) is displayed in parallel on the display (11R), squares (Q1) that are not displayed due to reaching the end of the first direction (direction Y1) are displayed again at the end of the second direction (direction Y2) at a time of a change to non-display or immediately after the change.

### Supplemental Note A4

In a specific example (supplemental note A4) of the supplemental note A3, the display controller (511) is configured to display, on the display (11R), all of the plurality of squares (Q1) in a manner that is simultaneously visible to a user. According to the aspect described above, in a state in which the plurality of squares (Q1) is displayed on the display (11R) such that all of the plurality of squares (Q1) are simultaneously visible to a user, each of the plurality of squares (Q1) is moved in the direction of the first axis (Y-axis). Thus, the user can visually and intuitively understand a state in which each of the plurality of squares (Q1) is adjacent to another one in the direction of the first axis (the Y-axis).

“Manner that is simultaneously visible to a user” means that all of the plurality of squares (Q1) are displayed in parallel. “Parallel” for a display of the plurality of squares (Q1) means that all of the plurality of squares (Q1) of the lottery card (C1) are displayed simultaneously on the display (11R). In other words, a state in which some squares (Q1) of the plurality of squares (Q1) are not displayed (in other words, a hidden state) does not correspond to “parallel.”

### Supplemental Note A5

In a specific example (supplemental note A5) of the supplemental note A3 or the supplemental note A4, the lottery executor (14) includes a first selector (12) configured to select one from among the plurality of display columns (L) and a second selector (512) configured to select, from among the two or more squares (Q1) included in a display column (L) selected by the first selector (12), a square (Q1) that is at a specific position at a time of selection by the first selector (12). According to the aspect described above, in a configuration in which the plurality of squares (Q1) is moved in the first direction (direction Y1), the square (Q1) is selected that is placed at the specific position at the time at which the selector selects a display column (L). Thus, it is easy for the user to visually understand that a square (Q1) is selected from among the plurality of squares (Q1) displayed on the display (11R).

“Specific position” is a position fixedly set relative to a display executed by the display (11R), for example. However, for example, when a predetermined condition is satisfied, the “specific position” may be changed.

### Supplemental Note A6

In a specific example (supplemental note A6) that is any one of the supplemental note A1 to the supplemental note A5, the display controller (511) is configured to change a display appearance of a square (Q1) among the plurality of squares (Q1) from a first appearance to a second appearance, wherein when the square (Q1) is selected by the lottery executor (14), a line of the predetermined number of squares (Q1) is completed. According to the aspect described above, it is possible for the user to visually and intuitively understand a square (Q1) that should be selected by lottery for completion of the line of the predetermined number of squares (Q1) in the selected state.

The display appearance means a characteristic of an image that can be visually distinguished by the user. For example, a sign (a letter or a symbol) displayed on, a display color of, a pattern (a drawing pattern) of, a size of, or a shape of each of the plurality of squares (Q1) is included in a concept of the “display appearance.” The display color is defined by hue (color tone), by saturation, or by shading (gradation).

### Supplemental Note A7

A game control method according to one aspect (supplemental note A7) of this disclosure includes displaying, by a game system (100), on a display (11R), a lottery card (C1) including a plurality of squares (Q1) divided into a plurality of display columns (L), each of the plurality of display columns (L) including two or more squares (Q1) aligned along a first axis (Y-axis), the plurality of display columns (L) being arranged along a second axis (X-axis) intersecting the first axis (Y-axis), repeatedly selecting, by the game system (100), one or more squares (Q1) from among the plurality of squares (Q1) by lottery, and considering, by the game system (100), among the two or more squares (Q1) included in each of the plurality of display columns (L) in the lottery card (C1), two squares (Q1) disposed at opposite ends from each other in a direction of the first axis (Y-axis), as adjacent squares (Q1), and determining, by the game system (100), whether a line of a predetermined number of squares (Q1) that are in a selected state is completed.

### Supplemental Note A8

A program according to one aspect (supplemental note A8) of this disclosure causes a computer system (100) to function as a display controller (511) configured to display, on a display (11R), a lottery card (C1) including a plurality of squares (Q1) divided into a plurality of display columns (L), each of the plurality of display columns (L) including two or more squares (Q1) aligned along a first axis (Y-axis), the plurality of display columns (Q1) being arranged along a second axis (X-axis) intersecting the first axis (Y-axis), a lottery executor (14) configured to repeatedly select one or more squares (Q1) from among the plurality of squares (Q1) by lottery; and a determiner (513) configured to consider, among the two or more squares (Q1) included in each of the plurality of display columns (L) in the lottery card (C1), two squares (Q1) disposed at opposite ends from each other in a direction of the first axis (Y-axis), as adjacent squares (Q1), and determine whether a line of a predetermined number of squares (Q1) that are in a selected state is completed.

### Supplemental Note B

There have been conventionally proposed lottery games in which rewards are given to a user due to a win in a lottery. For example, Patent Document B (Japanese Patent No. 7004211) discloses a configuration in which when a user loses a jackpot lottery, a jackpot preliminary lottery for a reattempt is executed by a coin being inserted.

However, to attempt the jackpot lottery again, the user is required to additionally insert a coin and to win the jackpot preliminary lottery; thus, it is actually difficult to maintain a user's expectation of winning a jackpot lottery attempted again. In view of the circumstances described above, an object of an aspect (supplement note B) of this disclosure is to prompt continuation of a game even when a user loses a lottery.

### Supplemental Note B1

To solve the above problems, a game system (100) according to one aspect (supplemental note B1) of this disclosure includes a first lottery executor (71, 75, 54) configured to execute a first lottery to select one from among a plurality of options (61) that includes an option (61) in a special state, a controller (54) configured to increase, when the option 61 that is in the special state is not selected by the first lottery, the option (61) in the special state among the plurality of options (61), and a second executor (12, 11R, 55) configured to execute, when the option (61) in the special state is selected by the first lottery and when a predetermined condition is satisfied, a second lottery in accordance with a number (K) of options (61) in the special state.

According to the aspect described above, when the option (61) that is in the special state is not selected by the first lottery, the option (61) in the special state is increased. Thus, the probability that the option (61) in the special state will be selected in a subsequent first lottery increases. In addition, when the option (61) in the special state is selected by the first lottery and when the predetermined condition is satisfied, the second lottery is executed in accordance with the number (K) of options (61) in the special state. In other words, a result of not selecting the option (61) in the special state in the first lottery affects the second lottery. As described above, even when the option (61) in the special state is not selected in the first lottery, it is possible to maintain an expectation that the option (61) in the special state will be selected in a subsequent first lottery; furthermore, it is possible to maintain an expectation that the second lottery will be executed in accordance with the number (K) of options (61) in the special state. Thus, compared to a configuration in which the number (K) of options (61) in the special state is fixed in the first lottery or a configuration in which the second lottery is not executed, even when no option (61) in the special state is selected in the first lottery (in other words, in a case of a loss in the first lottery), it is possible to prompt the user to continue a game.

The first lottery means a process of randomly selecting one from among the plurality of options (61). The second lottery is a process of determining whether the user wins or loses. For example, a lottery mechanism for executing a physical lottery by a mechanical mechanism, or an arithmetic device for executing an electronic lottery using an arithmetic process is given as an example of the “(first or second) lottery executor.” The first lottery executor (71, 75, 54) and the second lottery executor (12, 11R, 55) may be realized by individual lottery mechanisms that execute each of the lotteries, or may be realized using a common lottery mechanism.

“Execution of the second lottery in accordance with the number (K) of options (61) in the special state” means that a condition relating to the second lottery varies with the number (K) of options (61) in the special state. The condition relating to the second lottery is, for example, a condition relating to presence or absence of the second lottery, a condition relating to a method for the second lottery, or a condition relating to rewards for the second lottery. The condition relating to the method for the second lottery is, for example, the number of times that a lottery is executed in the second lottery. For example, the number of times that a lottery is executed in the second lottery is increased with an increase in the number of options (61) in the special state. The condition relating to the rewards for the second lottery is, for example, a value of rewards given to the user. The value of the rewards is, for example, a quantity of game media to be given to the user. For example, the greater the options (61) in the special state, the greater the quantity of rewards.

### Supplemental Note B2

In a specific example (supplemental note B2) of the supplemental note B1, the second lottery includes a unit lottery to be executed one or more times, and the second lottery executor (12, 11R, 55) controls, in accordance with the number (K) of options (61) in the special state, a number of times (M) that the unit lottery is executed. According to the aspect described above, the number of times (M) that the unit lottery is executed in the second lottery is controlled in accordance with the number (K) of options (61) in the special state. Thus, even when the option (61) in the special state is not selected in the first lottery, it is possible to effectively provide incentives for the user to continue the game.

A relationship between the number of times (M) relating to the unit lottery and the number (K) of options (61) in the special state may be freely selected. For example, the greater the number (K) of options (61) in the special state, the greater the number of times (M) relating to the unit lottery. However, the relationship between the number of times (M) relating to the unit lottery and the number (K) of options (61) in the special state is not limited to the above example. For example, a section may be set in which the number of times (M) relating to the unit lottery is not changed in accordance with a change in the option (61) in the special state (widely increasing).

### Supplemental Note B3

In a specific example (supplemental note B3) of the supplemental note B1 or the supplemental note B2, the second lottery executor (12, 11R, 55) executes the second lottery when the number (K) of options (61) in the special state is greater than a threshold. According to the aspect described above, whether the second lottery is executed is controlled in accordance with the number (K) of options (61) in the special state. Thus, even when no option (61) in the special state is selected in the first lottery, it is possible to effectively provide incentives for the user to continue the game.

### Supplemental Note B4

In a specific example (supplemental note B4) that is any one of the supplemental note B1 to the supplemental note B3, the second lottery executor (12, 11R, 55) sets, in accordance with the number (K) of options (61) in the special state, rewards that are to be given to the user depending on a result of the second lottery. According to the aspect described above, a quantity of rewards to be given to the user depending on the result of the second lottery is controlled in accordance with the number (K) of options (61) in the special state. Thus, even when no option (61) in the special state is selected in the first lottery, it is possible to effectively provide incentives for the user to continue the game.

“Controlling, in accordance with the number (K) of options (61) in the special state, the rewards that are to be given to the user” means that the rewards that are to be given to the user varies depending on the number (K) of options (61) in the special state. Specifically, a value of the rewards is changed in accordance with the number (K) of options (61) in the special state. The value of the rewards is, for example, a quantity of rewards to be given to the user. The quantity of rewards is, for example, a quantity of game media to be given to the user. For example, the greater the number (K) of options (61) in the special state, the greater the quantity of rewards. In addition, for example, in a configuration in which an item is given as rewards to the user, a value of the item is “the value of the rewards.” The value of the item is a level of rarity (rare or normal, etc.) of the item to be given to the user, or is a level of effectiveness of the item, for example. For example, an item is given to the user, the item having a level of rarity or a level of effectiveness that enhances with an increase in the number of options (61) in the special state.

The relationship between the value of the rewards and the number (K) of options (61) in the special state may be freely selected. For example, the value of the rewards dependent on the result of the second lottery is increased with an increase in the number of options (61) in the special state. However, the relationship between the value of the rewards and the number (K) of options (61) in the special state is not limited to the above example. For example, a section may be set in which the value of the rewards is not changed in accordance with a change in the option (61) in the special state (widely increasing). In addition, the second lottery executor (12, 11R, 55) may control both the number of times (M) relating to the unit lottery and the value of the rewards in accordance with the number (K) of options (61) in the special state.

### Supplemental Note B5

In a specific example (supplemental note B5) that is any one of the supplemental note B1 to the supplemental note B4, a special lottery executor (U) is further included that configured to execute, when the option (61) in the special state is selected by the first lottery, a special lottery to determine whether the user wins or loses, and the predetermined condition includes a condition in that a result of the special lotter is a win. According to the aspect described above, the special lottery is executed when the option (61) in the special state is selected in the first lottery, and the second lottery is executed subject to a win in the special lottery. Thus, the user can expect, in addition to rewards to be given to the user due to a win in the special lottery, rewards due to the second lottery being executed in accordance with the number (K) of options (61) in the special state.

### Supplemental Note B6

In a specific example (supplemental note B6) that is any one of the supplemental note B1 to the supplemental note B5, an attribute lottery executor (74) is further included that configured to execute an attribute lottery to determine one among a plurality of attributes (An), states of the plurality of options (61) are stored in a storage device (82) for each of the plurality of attributes (An), the first lottery is a process of selecting one from among the plurality of options (61) in states stored for an attribute (An) determined by the attribute lottery, and the special lottery is a special lottery, corresponding to the attribute (An) selected by the attribute lottery, among a plurality of special lotteries corresponding to the different attributes (An). According to the aspect described above, the first lottery and the special lottery are individually managed for each of the plurality of attributes (An). Thus, various game developments are realized in accordance with the result of the attribute lottery.

### Supplemental Note B7

In a specific example (supplemental note B7) that is any one of the supplemental note B1 to the supplemental note B6, a state of each of the plurality of options (61) is changed stepwise until the special state each time selection is executed in the first lottery. According to the aspect described above, the state of each of the plurality of options (61) is changed stepwise until the special state each time selection is executed in the first lottery. Thus, the user can understand a process of increasing the number (K) of options (61) in the special state among the plurality of options (61). As will be understood from the above description, an option (61) that does not reach the special state among the plurality of options (61) is changed stepwise by being selected by the first lottery, and is eventually changed to being in the special state; thus, the number (K) of options (61) in the special state is increased among the plurality of options (61).

### Supplemental Note B8

A game control method according to one aspect (supplemental note B8) of this disclosure includes executing, by a game system (100), a first lottery to select one from among a plurality of options (61) that includes an option (61) in a special state, increasing, by the game system (100), when the option 61 that is in the special state is not selected by the first lottery, the option (61) in the special state among the plurality of options (61), and executing, by the game system (100), when the option (61) in the special state is selected by the first lottery and when a predetermined condition is satisfied, a second lottery in accordance with the number (K) of options (61) in the special state.

### Supplemental Note B9

A program according to one aspect (supplemental note B9) of this disclosure causes a computer system to function as a first lottery executor (71, 75, 54) configured to execute a first lottery to select one from among a plurality of options (61) that includes an option (61) in a special state, a controller (54) configured to increase, when the option 61 that is in the special state is not selected by the first lottery, the option (61) in the special state among the plurality of options (61), and a second executor (12, 11R, 55) configured to execute, when the option (61) in the special state is selected by the first lottery and when a predetermined condition is satisfied, a second lottery in accordance with the number (K) of options (61) in the special state.

### Supplemental Note C

There have been conventionally proposed lottery games for randomly selecting one from among a plurality of options. For example, Patent Document C (Japanese Patent No. 5098468) discloses a bingo game in which when a win is established in a bingo sheet for a main game, in a bingo sheet for a secondary game, a number square corresponding to a winning number that becomes valid due to the establishment of the win is valid.

In addition, such a bingo game disclosed in Patent Document C is a monotonous game in which a number is selected from among a plurality of numbers corresponding to respective squares on the bingo sheet; thus, it is actually difficult to sufficiently maintain a user's expectation of a win and an interest in the game. In view of the circumstances described above, an object of an aspect (supplement note C) of this disclosure is to provide a high entertaining game that causes a user's expectation of satisfaction of a winning condition to be maintained.

### Supplemental Note C1

To solve the above problems, a game system (100) according to one aspect (supplemental note C1) of this disclosure includes a lottery executor (26) configured to execute a first lottery to select one from among a plurality of options that includes a special option and a plurality of usual options and a second lottery to select one from among two or more usual options, which include a target option, among the plurality of usual options when the special option is selected by the first lottery, and a determiner (522) configured to determine whether a wining condition is satisfied in a result of selection of the usual option in the first lottery or in the second lottery, wherein the target option is a usual option that causes the winning condition to be satisfied when selected from among the plurality of usual options, and wherein a probability that the target option is selected in the second lottery is greater than a probability that the target option is selected in the first lottery.

According to the aspect described above, when the special option is selected from among the plurality of options, the second lottery is executed that causes the target option, which contributes to the satisfaction of the winning condition, to be selected with high probability compared to the first lottery. Thus, the user not only expects satisfaction of the winning condition caused by selection of a usual option in the first lottery, but also expects satisfaction of the winning condition caused by selection of a target option with high probability in the second lottery when the special option is selected. In other words, compared to a configuration in which one of the plurality of usual options is simply selected by lottery, it is possible to provide a high entertaining game that causes a user's expectation of satisfaction of the winning condition to be maintained.

“(First or second) lottery” means a process of randomly selecting one from among a plurality of options. For example, a lottery mechanism for executing a physical lottery by a mechanical mechanism, or an arithmetic device for executing an electronic lottery using an arithmetic process is given as an example of the “lottery executor (26).” The “lottery executor (26)” is a lottery mechanism provided in the real space, a lottery mechanism provided in a virtual space, or a lottery function for executing an electronic lottery through arithmetic processing by an arithmetic device. The lottery executor (26) may include an element for executing the first lottery and an element for executing the second lottery individually, or may be constituted of a common element that can execute both the first lottery and the second lottery.

The “usual option” is an option used to determine whether the winning condition is satisfied. The “target option” is an option that causes the winning condition to be satisfied when selected by the first lottery or by the second lottery from among the plurality of usual options.

On the other hand, the “special option” is a specific option, which triggers the second lottery, among the plurality of options that are candidates for selection by the first lottery. The special option is an option that does not directly contribute to whether the winning condition is satisfied. In other words, whether the special option is selected is independent from whether the winning condition is satisfied. The plurality of options includes one or more special options.

The “winning condition” is a condition for determining whether the user wins or loses, and is a condition depending to a result of selection of a usual option. For example, when a lottery card is assumed in which a plurality of squares (Q2) corresponding to different usual options are arranged in a matrix, a condition for an arrangement of two or more squares (Q2) including a square (Q2) corresponding to a usual option selected by the first lottery or by the second lottery is given as an example of the “winning condition.”

It should be noted that a process for realizing a state in which the probability that the target option is selected in the second lottery is greater than the probability that the target option is selected in the first lottery may be freely selected. For example, by a configuration in which the number of usual options that are selection candidates for the second lottery is less than the number of usual options that are selection candidates for the first lottery, the state described above is realized. Alternatively, a configuration is assumed in which a ratio of the number of target options to the number of usual options to be selection candidates in the second lottery is greater than the ratio in the first lottery.

### Supplemental Note C2

In a specific example (supplemental note C2) of the supplemental note C1, a number of usual options that are selection candidates for the second lottery is less than a number of usual options that are selection candidates for the first lottery. According to the aspect described above, by the number of usual options that are selection candidates for the second lottery being less than that for the first lottery, the state in which the probability that the target option is selected in the second lottery is greater than the probability that the target option is selected in the first lottery is realized.

### Supplemental Note C3

In a specific example (supplemental note C3) of the supplemental note C1 or the supplemental note C2, a display controller (521) is further included that configured to display a plurality of squares (Q2) in one-to-one correspondence with the plurality of usual options on a display (25) and to set a square (Q2) corresponding to a usual option selected by the first lottery or by the second lottery to a selected state, and the winning condition is a condition relating to an arrangement of two or more squares (Q2) in the selected state among the plurality of squares (Q2). According to the aspect described above, the square (Q2) corresponding to the usual option selected by the first lottery or by the second lottery is set to the selected state, and whether the winning condition is satisfied is determined in the arrangement of the two or more squares (Q2) in the selected state. Thus, the user can visually or intuitively understand, in the arrangement of the plurality of squares (Q2), whether the winning condition is satisfied.

### Supplemental Note C4

In a specific example (supplemental note C4) of the supplemental note C3, the target option is a usual option corresponding to a square (Q2) in a non-selected state among the plurality of squares (Q2). According to the aspect described above, when the target option is selected in the second lottery, a state of a square corresponding to the target option (Q2) is changed from the non-selected state to the selected state. In other words, a game using the plurality of squares (Q2) progresses. Thus, it is possible to give the user an expectation of satisfaction of the winning condition.

### Supplemental Note C5

In a specific example (supplemental note C5) of the supplemental note C3 or the supplemental note C4, a reward giver 523 is further included that configured to give a user rewards corresponding to a number of times that the winning condition is satisfied, and the target option is a usual option selected in descending order of value of rewards given to the user when the winning condition is satisfied, from among the plurality of usual options. According to the aspect described above, the target option is selected in descending order of quantity of rewards given to the user. Thus, it is possible to give the user an expectation of acquiring a large quantity of rewards.

The “value of the rewards” is, for example, a quantity of rewards to be given to the user. The quantity of rewards is, for example, a quantity of game media to be given to the user. For example, the greater the number of special options, the greater the quantity of rewards. In addition, for example, in a configuration in which an item is given as rewards to the user, a value of the item is “the value of the rewards.” The value of the item is a level of rarity (rare or normal, etc.) of the item to be given to the user, or is a level of effectiveness of the item, for example. For example, an item with high rarity or with high effectiveness has a high value in rewards.

### Supplemental Note C6

In a specific example (supplemental note C6) of the supplemental note C3 or the supplemental note C4, the target option is a usual option, which is capable of causing the winning condition to be satisfied in two or more arrangements that are constituted of different combinations of squares (Q2) when selected, among the plurality of usual options. According to the aspect described above, the usual option, which is capable of causing the winning condition to be satisfied in the two or more arrangements that are constituted of the different combinations of squares (Q2), becomes a candidate for selection by the second lottery as the target option. Thus, it is possible to give the user an expectation of satisfaction of the winning condition in a plurality of arrangements.

### Supplemental Note C7

In a specific example (supplemental note C7) that is any one of the supplemental note C1 to the supplemental note C5, the two or more usual options that are candidates for selection by the second lottery include a usual option that causes the winning condition not to be satisfied when the usual option is selected. According to the aspect described above, the usual option that causes the winning condition not to be satisfied when selected is included in the candidates for selection by the second lottery. In other words, as a result of the second lottery, a case in which the winning condition is satisfied or a case in which the winning condition is not satisfied may occur. Thus, it is easy to maintain interest in the game compared to a configuration in which the winning condition is always satisfied as a result of the second lottery.

### Supplemental Note C8

In a specific example (supplemental note C8) that is any one of the supplemental note C1 to the supplemental note C7, the lottery executor (26) includes a first lottery apparatus configured to execute the first lottery (21), and a second lottery apparatus configured to execute the second lottery (22). According to the aspect described above, each of the first lottery and the second lottery is executed by a different lottery apparatus. Thus, compared to a configuration in which a lottery apparatus is used for the first lottery and for the second lottery, it is possible to provide a variety of games with high interest.

### Supplemental Note C9

A game control method according to one aspect (supplemental note C9) of this disclosure includes executing, by a game system (100), a first lottery to select one from among a plurality of options that includes a special option and a plurality of usual options and a second lottery to select one from among two or more usual options, which include a target option, among the plurality of usual options when the special option is selected by the first lottery, and determining, by a game system (100), whether a wining condition is satisfied in a result of selection of the usual option in the first lottery or in the second lottery, wherein the target option is a usual option that causes the winning condition to be satisfied when selected from among the plurality of usual options, and wherein a probability that the target option is selected in the second lottery is greater than a probability that the target option is selected in the first lottery.

### Supplemental Note C10

A program according to one aspect (supplemental note C10) of this disclosure causes a computer system (100) to function as a lottery executor (26) configured to execute a first lottery to select one from among a plurality of options that includes a special option and a plurality of usual options and a second lottery to select one from among two or more usual options, which include a target option, among the plurality of usual options when the special option is selected by the first lottery, and a determiner (522) configured to determine whether a wining condition is satisfied in a result of selection of the usual option in the first lottery or in the second lottery, wherein the target option is a usual option that causes the winning condition to be satisfied when selected from among the plurality of usual options, and wherein a probability that the target option is selected in the second lottery is greater than a probability that the target option is selected in the first lottery.

### DESCRIPTION OF REFERENCE SIGNS

100 . . . game system, 11L, 11R, 25, 31, 71 . . . display, 12 . . . selection apparatus, 13, 76 . . . feeding apparatus, 14 . . . lottery executor, 21, 22, 32, 74, 75 . . . lottery apparatus, 26 . . . lottery mechanism, 54 . . . first controller, 55 . . . second controller, 60 . . . lottery image, 61 . . . option, 62 . . . indication image, 70 . . . station, 72 . . . operation panel, 73 . . . game apparatus, 81 . . . controller, 82 . . . storage device, 121 . . . waiting path, 122 . . . rotor, 123 . . . target path, 124 . . . holder, 211, 221, 321 . . . lottery board, 212, 222, 322 . . . drive device, 213, 223, 323 . . . feeding apparatus, 214, 225, 324 . . . lottery hole, 224 . . . display, 311, 311a . . . option, 511 . . . display controller, 512 . . . selector, 513 . . . determiner, 521 . . . display controller, 522 . . . determiner, 523 . . . reward giver, 721 . . . operation device, 722 . . . receiving device, 723 . . . payout device, 731 . . . fixed table, 732 . . . movable table, 733 . . . feeding apparatus, 734 . . . fixed wall, 735 . . . lottery hole, 751 . . . lottery apparatus, B . . . special ball, B1, B21, B22, B3, Ba, Bb . . . lottery ball, C1, C2 . . . lottery card, C3 . . . reward card, P . . . target point, U . . . central unit, U1, U2, U3 . . . lottery unit.

What is claimed is:

1. A game system comprising:
one or more memories configured to store instructions; and
one or more processors configured to execute the instructions to:
display, on a display, a lottery card including a plurality of squares divided into a plurality of display columns, each of the plurality of display columns including two or more squares aligned along a first axis, the plurality of display columns being arranged along a second axis intersecting the first axis;
repeatedly select one or more squares from among the plurality of squares by lottery;
consider, among the two or more squares included in each of the plurality of display columns in the lottery card, two squares disposed at opposite ends from each other in a direction of the first axis, as adjacent squares; and
determine whether a line of a predetermined number of squares that are in a selected state is completed.

2. The game system according to claim 1, wherein the one or more processors are further configured to execute the instructions to consider, among two or more squares aligned along the second axis in the lottery card, two squares disposed at opposite ends from each other in a direction of the second axis, as adjacent squares.

3. The game system according to claim 1, wherein the one or more processors are configured to execute the instructions to:
move the plurality of squares in a first direction along the first axis; and
move a respective square that reaches an end in the first direction among the plurality of squares to an end in a second direction opposite to the first direction.

4. The game system according to claim 3, wherein the one or more processors are configured to execute the instructions to display, on the display, all of the plurality of squares in a manner that is simultaneously visible to a user.

5. The game system according to claim 3, wherein the one or more processors are configured to execute the instructions to:
execute a first selection of one from among the plurality of display columns; and
execute a second selection of, from among the two or more squares included in a display column selected by the first selection, a square that is at a specific position at a time of the first selection.

6. The game system according to claim 1, wherein the one or more processors are configured to execute the instructions to change a display appearance of a square among the plurality of squares from a first appearance to a second appearance, wherein when the square is selected by the one or more processors, a line of the predetermined number of squares is completed.

7. A game control method comprising:
displaying, by a game system, on a display, a lottery card including a plurality of squares divided into a plurality of display columns, each of the plurality of display columns including two or more squares aligned along a first axis, the plurality of display columns being arranged along a second axis intersecting the first axis;
repeatedly selecting, by the game system, one or more squares from among the plurality of squares by lottery; and
considering, by the game system, among the two or more squares included in each of the plurality of display columns in the lottery card, two squares disposed at opposite ends from each other in a direction of the first axis, as adjacent squares, and determining, by the game system, whether a line of a predetermined number of squares that are in a selected state is completed.

8. A non-transitory computer-readable recording medium storing instructions executable by a computer system configured to execute the instructions to:
display, on a display, a lottery card including a plurality of squares divided into a plurality of display columns, each of the plurality of display columns including two or more squares aligned along a first axis, the plurality of display columns being arranged along a second axis intersecting the first axis;
repeatedly select one or more squares from among the plurality of squares by lottery;
consider, among the two or more squares included in each of the plurality of display columns in the lottery card, two squares disposed at opposite ends from each other in a direction of the first axis, as adjacent squares; and
determine whether a line of a predetermined number of squares that are in a selected state is completed.
